(19) United States
(12) Patent Application Publication
(10) Pub. No.: US 2020/0184591 A1
(43) Pub. Date: Jun. 11, 2020

(54) System and Methods for Analyzing Roadside Assistance Service of Vehicles in Real Time

(71) Applicant: Allstate Insurance Company, Northbrook, IL (US)

(72) Inventors: Govinda Balu, Palatine, IL (US); Lourdes M. Link, Northfield, IL (US); Mohammed Ali, Palatine, IL (US)

(21) Appl. No.: 16/214,384

(22) Filed: Dec. 10, 2018

(51) Int. Cl. G06Q 50/30; G06Q 40/08; G07C 5/08

(52) U.S. Cl. CPC G06Q 50/30; G07C 5/0816; G06Q 40/08

(57) ABSTRACT

Systems, apparatuses, and methods for providing roadside assistance services are described herein. The system may include network computing devices and computing devices associated with user vehicles and service vehicles. The system may predict incoming requests for roadside assistance services, and may allocate service providers among various geographical regions and/or time slots to handle the incoming requests. The system may receive a request for a roadside assistance service from a user. The system may select an appropriate service provider to assist the user, and may assign the service request to the selected service provider.

### FIELD OF ART

Aspects described herein generally relate to computer and network hardware and software. In particular, the present disclosure relates to systems and methods for analyzing roadside assistance service of vehicles in real time.

### BACKGROUND

Vehicles may become disabled during a trip because of, for example, a vehicle malfunction, an accident, etc. A disabled vehicle may be a stressful situation for an owner or operator of a vehicle. The drivers and/or passengers of the disabled vehicle may contact a towing network for assistance. In some situations, the towing network might not have available service vehicles, replacement parts, or repair know how to assist the disabled vehicle. Additionally, some vehicles may breakdown more than others and may need special assistance. There is still a need for an ability to analyze roadside assistance service characteristics of various vehicles, e.g., to forecast roadside assistance service, vehicle breakdown, and/or vehicle recall.

### BRIEF SUMMARY

The following summary presents a simplified summary of certain features. The summary is not an extensive overview and is not intended to identify key or critical elements.

Systems, apparatuses, and methods for analyzing roadside assistance service of vehicles in real time are described herein. The system may include network computing devices and computing devices associated with user vehicles, service vehicles, and vehicle manufacturers and/or dealers. The system may predict incoming requests for roadside assistance services, and may allocate service providers among various geographical regions and/or time slots to handle the incoming requests. The system may receive a request for a roadside assistance service from a user or user device. The system may select an appropriate service provider to assist the user, and may assign the service request to the selected service provider. The system may also display, e.g., via a user interface or portal, data involving vehicles that had, are having, or will have roadside assistance services; the locations and types of roadside assistance services; the service providers available to provide roadside assistance services; the quality of the roadside assistance service(s) and/or service provider(s); and the like.

In accordance with some embodiments of the present disclosure, a system comprises: one or more processors; and memory storing computer-executable instructions that, when executed by the one or more processors, cause the system to: receive a request to treat a current breakdown of at least an aspect of a vehicle, wherein the request includes a vehicle location and a vehicle identification; identify, from a plurality of stored vehicle profiles, a vehicle profile based on the vehicle identification; determine, based on the vehicle location and a breakdown characteristic of the vehicle, (1) a service to treat the current breakdown, and (2) a service vehicle from a plurality of service vehicles to render the service; and update the identified vehicle profile based on one or more of: the vehicle location, the breakdown characteristics of the vehicle, and the service rendered.

In accordance with other embodiments of the present disclosure, one method includes: receiving a request to treat a current breakdown of at least an aspect of a vehicle, wherein the request includes a vehicle location and a vehicle identification; identifying, from a plurality of stored vehicle profiles, a vehicle profile based on the vehicle identification; determining, based on the vehicle location and a breakdown characteristic of the vehicle, (1) a service to treat the current breakdown, and (2) a service vehicle from a plurality of service vehicles to render the service; and updating the identified vehicle profile based on one or more of: the vehicle location, the breakdown characteristics of the vehicle, and the service rendered.

In accordance with another embodiment of the present disclosure, one method includes: receiving a request to forecast a future breakdown of a consumer vehicle; identifying, from a plurality of stored vehicle profiles, a vehicle profile based on the vehicle identification of the consumer vehicle; determining, from the identified vehicle profile and for each of a plurality of vehicles represented by the vehicle profile, one or more of a breakdown characteristic, a service, and a vehicle location during a past breakdown; forecasting a future breakdown of the consumer vehicle based on the determined breakdown characteristic, service, and vehicle location for each of the plurality of vehicles represented by the vehicle profile, wherein the forecast of the future breakdown includes at least a breakdown characteristic of the consumer vehicle and a vehicle location during the forecasted breakdown.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows one example operating environment in which one or more aspects described herein may be implemented.

FIG. 2 is a schematic diagram showing an example system for analyzing roadside assistance service of vehicles in real time, according to one or more aspects described herein.

FIGS. 3A-3E illustrate a flowchart showing an example method for analyzing roadside assistance service of vehicles in real time, according to one or more aspects described herein.

FIG. 4 illustrates a flowchart showing an example method for predicting a future roadside assistance service parameter, in accordance with one or more aspects described herein.

FIGS. 5A-5D illustrate a flowchart showing an example method for processing a request for a roadside assistance service in accordance with one or more aspects described herein.

FIGS. 6A-6D are exemplary displays of a user interface for analyzing roadside assistance service of vehicles in real time, according to one or more aspects described herein.

FIG. 7 is a schematic diagram showing an example system for determining roadside assistance service parameters according to one or more aspects described herein.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

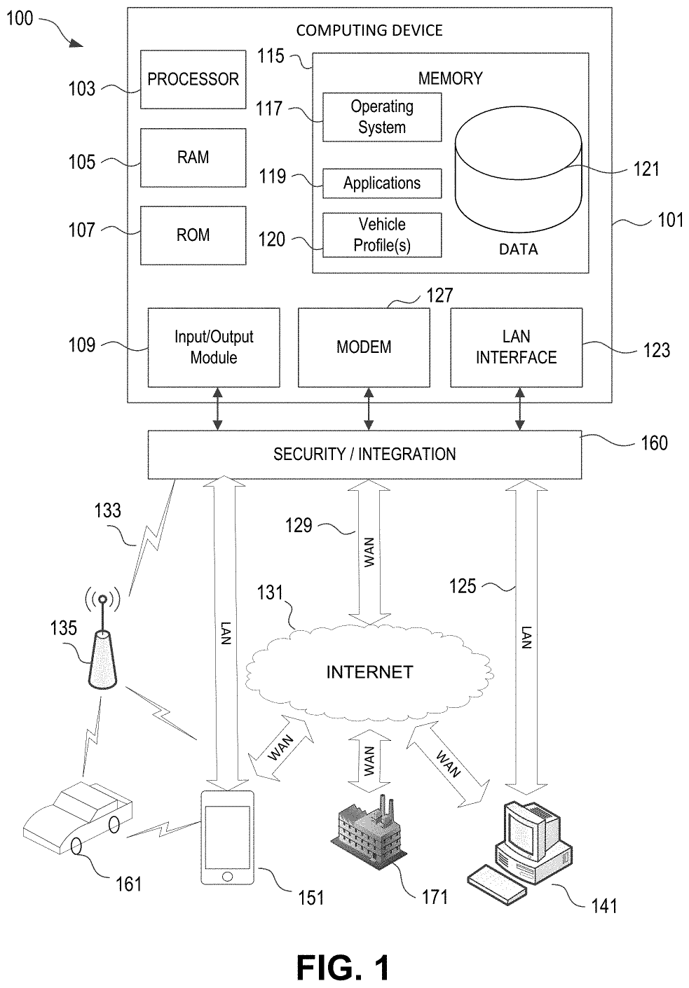

FIG. 1 shows a block diagram of an example computing device (or system) 101 in a computer system 100 for analyzing roadside assistance service or vehicles in real time (“computing device”, “computer system,” etc.) that may be used according to one or more illustrative embodiments of the disclosure. For example, the computing system 101 may be utilized by a client user (e.g., a vehicle manufacturer, a vehicle dealer, a parts manufacturer, a service provider network). For simplicity, such a computing system 101 or computing device 101 may be referred to as “client portal,” “client portal computing device,” “client portal computing system,” and/or “client portal server.” In another example, the computing system 101 or computing device 101 may be utilized by a vehicle user seeking roadside assistance service or a service provider user seeking to provide or facilitate roadside assistance service. For simplicity, such a computing system 101 or computing device 101 may be referred to as “roadside assistance service computing device,” “roadside assistance service computing system,” and/or “roadside assistance service server.” The computing device 101 may have a processor 103 for controlling overall operation of the device 101 and its associated components, including RAM 105, ROM 107, input/output module 109, and memory 115. As explained above, the computing device 101, along with one or more additional devices (e.g., terminals 141 and 151, security and integration hardware 160) may correspond to any of multiple systems or devices described herein, such as personal mobile devices, vehicle-based computing devices, insurance systems servers, roadside assistance provider servers, roadside assistance service servers, devices or servers belonging to a vehicle manufacturer or dealer, internal data sources, external data sources, and other various devices in a roadside assistance service system. These various computing systems may be configured individually or in combination, as described herein, for receiving signals and/or transmissions from one or more computing devices, the signals or transmissions including data related to location of vehicle(s), operating parameters of vehicle(s), operating parameters of vehicle(s) in a same or similar location to the vehicle(s), and the like, processing the signals or transmissions to determine a location of the vehicle(s), a cause of an issue associated with the vehicle(s), and the like, using the devices of the systems for analyzing roadside assistance services in real time described herein. In addition to the features described above, the techniques described herein also may be used for generating and displaying one or more different types of notifications, real time alerts (e.g., weather conditions), transmitting a request for assistance to a service center computing device, providing data analytics for a specific vehicle or vehicle type, forecasting future roadside assistance service or breakdown for a vehicle or vehicle type, and the like.

Input/Output (I/O) 109 may include a microphone, keypad, touch screen, and/or stylus through which a user of the computing device 101 (e.g., a vehicle manufacturer and/or dealer, a vehicle user, a service provider, etc.) may provide input, and may also include one or more of a speaker for providing audio output and a video display device for providing textual, audiovisual and/or graphical output. Software may be stored within memory 115 and/or storage to provide instructions to processor 103 for enabling device 101 to perform various actions. For example, memory 115 may store software used by the device 101, such as an operating system 117, application programs 119, information identifying vehicle(s) and their vehicle manufacturer(s) or dealer(s) (e.g., “vehicle profile(s)” 120), and an associated internal database 121. The various hardware memory units in memory 115 may include volatile and nonvolatile, removable and non-removable media implemented in any method or technology for storage of information such as computer-readable instructions, data structures, program modules or other data. Certain devices and systems within computing systems may have minimum hardware requirements in order to support sufficient storage capacity, processing capacity, analysis capacity, network communication, etc. For instance, in some embodiments, one or more nonvolatile hardware memory units having a minimum size (e.g., at least 1 gigabyte (GB), 2 GB, 5 GB, etc.), and/or one or more volatile hardware memory units having a minimum size (e.g., 256 megabytes (MB), 512 MB, 1 GB, etc.) may be used in a device 101 (e.g., a personal mobile device 101, vehicle-based device 101, roadside assistance server 101, client portal server 101, client portal device 101, etc.), in order to receive and analyze the signals, transmissions, etc. including location information, vehicle operating information, and the like, determine a location of the vehicle, determine a cause of an issue associated with the vehicle, generate and transmit notifications and real time alerts, provide data and data analytics for a specific vehicle or vehicle type, forecast future roadside assistance service or breakdown for a vehicle or vehicle type, and the like, using the various devices of the system described above. Memory 115 also may include one or more physical persistent memory devices and/or one or more non-persistent memory devices. Memory 115 may include, but is not limited to, random access memory (RAM) 105, read only memory (ROM) 107, electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by processor 103.

Processor 103 may include a single central processing unit (CPU), which may be a single-core or multi-core processor (e.g., dual-core, quad-core, etc.), or may include multiple CPUs. Processor(s) 103 may have various bit sizes (e.g., 16-bit, 32-bit, 64-bit, 96-bit, 128-bit, etc.) and various processor speeds (ranging from 100 MHz to 5 Ghz or faster). Processor(s) 103 and its associated components may allow the system 101 to execute a series of computer-readable instructions, for example, receive signals or transmissions including location information, vehicle operation information, scan for diagnostic codes, and the like, to determine a location of the vehicle, determine a cause of an issue associated with the vehicle, control amount and type of data received, receive or relay vehicle profile information, analyze breakdown data of like vehicles, forecast vehicle breakdowns, and the like.

The computing device (e.g., a personal mobile device, vehicle-based system, insurance system server, roadside assistance service server, client portal device, client portal server, etc.) may operate in a networked environment 100 supporting connections to one or more remote computers, such as terminals 141, 151, 161, and 171. Such terminals may be personal computers or servers 141 (e.g., home computers, laptops, web servers, database servers), mobile communication devices 151 (e.g., mobile phones, tablet computers, etc.), vehicle-based computing systems 161 (e.g., on-board vehicle systems, telematics devices, mobile phones or other personal mobile devices within vehicles), computing systems of vehicle manufacturers or dealers (“client portal devices”) 171, and the like, each of which may include some or all of the elements described above with respect to the road segment evaluation computing device 101. The network connections depicted in FIG. 1 include a local area network (LAN) 125 and a wide area network (WAN) 129, and a wireless telecommunications network 133, but may also include other networks. When used in a LAN networking environment, the computing device 101 may be connected to the LAN 125 through a network interface or adapter 123. When used in a WAN networking environment, the device 101 may include a modem 127 or other means for establishing communications over the WAN 129, such as network 131 (e.g., the Internet). When used in a wireless telecommunications network 133, the device 101 may include one or more transceivers, digital signal processors, and additional circuitry and software for communicating with wireless computing devices 151 and 161 (e.g., mobile phones, portable customer computing devices, vehicle-based computing devices and systems, etc.) via one or more network devices 135 (e.g., base transceiver stations) in the wireless network 133.

Also illustrated in FIG. 1 is a security and integration layer 160, through which communications are sent and managed between the device 101 (e.g., a personal mobile device, a vehicle-based computing device, a roadside assistance server or computing platform, a client portal server or device, a computing system of a vehicle manufacturer or dealer, an intermediary server and/or external data source servers, etc.) and the remote devices (141, 151, 161, and 171) and remote networks (125, 129, and 133). The security and integration layer 160 may comprise one or more separate computing devices, such as web servers, authentication servers, and/or various networking components (e.g., firewalls, routers, gateways, load balancers, etc.), having some or all of the elements described above with respect to the computing device 101. As an example, a security and integration layer 160 of a server 101 may comprise a set of web application servers configured to use secure protocols and to insulate the device 101 from external devices 141, 151, 161, and 171. In some cases, the security and integration layer 160 may correspond to a set of dedicated hardware and/or software operating at the same physical location and under the control of same entities as device 101. For example, layer 160 may correspond to one or more dedicated web servers and network hardware in a vehicle and driver information datacenter or in a cloud infrastructure supporting cloud-based vehicle identification, location identification, vehicle operational parameters identification, issue detection, and the like. In other examples, the security and integration layer 160 may correspond to separate hardware and software components which may be operated at a separate physical location and/or by a separate entity. Alternatively or additionally, the security and integration layer 160 may insulate the client portal system 101 and/or the computing system of the vehicle manufacturer or dealer 171 from other external devices (e.g., 161, 151, 141, etc.)

As discussed below, the data transferred to and from various devices in a roadside assistance service system 100 may include secure and sensitive data, such as confidential vehicle operation data, insurance policy data, vehicle profile data, and confidential user data from drivers and passengers in vehicles. Therefore, it may be desirable to protect transmissions of such data by using secure network protocols and encryption, and also to protect the integrity of the data when stored on the various devices within a system, such as personal mobile devices, vehicle-based devices, insurance servers, roadside assistance servers, client portal servers, external data source servers, or other computing devices in the system 100, by using the security and integration layer 160 to authenticate users and restrict access to unknown or unauthorized users. In various implementations, security and integration layer 160 may provide, for example, a file-based integration scheme or a service-based integration scheme for transmitting data between the various devices in an electronic display system 100. Data may be transmitted through the security and integration layer 160, using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In other examples, one or more web services may be implemented within the various devices 101 in the system 100 and/or the security and integration layer 160. The web services may be accessed by authorized external devices and users to support input, extraction, and manipulation of the data (e.g., vehicle data, driver data, location data, roadside assistance issue data, etc.) between the various devices 101 in the system 100. Web services built to support a personalized display system may be cross-domain and/or cross-platform, and may be built for enterprise use. Such web services may be developed in accordance with various web service standards, such as the Web Service Interoperability (WS-I) guidelines. In some examples, a driver data, vehicle data, location data, roadside assistance issue data and/or roadside assistance data analysis web service, or the like, may be implemented in the security and integration layer 160 using the Secure Sockets Layer (SSL) or Transport Layer Security (TLS) protocol to provide secure connections between servers 101 and various clients 141, 151, 161, and 171. SSL or TLS may use HTTP or HTTPS to provide authentication and confidentiality. In other examples, such web services may be implemented using the WS-Security standard, which provides for secure SOAP messages using XML encryption. In still other examples, the security and integration layer 160 may include specialized hardware for providing secure web services. For example, secure network appliances in the security and integration layer 160 may include built-in features such as hardware-accelerated SSL and HTTPS, WS-Security, and firewalls. Such specialized hardware may be installed and configured in the security and integration layer 160 in front of the web servers, so that any external devices may communicate directly with the specialized hardware.

Although not shown in FIG. 1, various elements within memory 115 or other components in system 100, may include one or more caches, for example, CPU caches used by the processing unit 103, page caches used by the operating system 117, disk caches of a hard drive, and/or database caches used to cache content from database 121. For embodiments including a CPU cache, the CPU cache may be used by one or more processors in the processing unit 103 to reduce memory latency and access time. In such examples, a processor 103 may retrieve data from or write data to the CPU cache rather than reading/writing to memory 115, which may improve the speed of these operations. In some examples, a database cache may be created in which certain data from a database 121 (e.g., a database of driver data, database of vehicle information, database of location information, database of roadside assistance issue information, etc.) is cached in a separate smaller database on an application server separate from the database server (e.g., at a personal mobile device, vehicle-based data, or intermediary network device or cache device, etc.). For instance, in a multi-tiered application, a database cache on an application server can reduce data retrieval and data manipulation time by not needing to communicate over a network with a back-end database server. These types of caches and others may be included in various embodiments, and may provide potential advantages in certain implementations of roadside assistance service systems and client portal systems, such as faster response times and less dependence on network conditions when transmitting and receiving driver information, vehicle information, location information, roadside assistance issue information, real time alerts, and the like.

It will be appreciated that the network connections shown are illustrative and other means of establishing a communications link between the computers may be used. The existence of any of various network protocols such as TCP/IP, Ethernet, FTP, HTTP and the like, and of various wireless communication technologies such as GSM, CDMA, WiFi, and WiMAX, is presumed, and the various computing devices in the system components described herein may be configured to communicate using any of these network protocols or technologies.

Additionally, one or more application programs 119 may be used by the various computing devices 101 within a computing system 100 (e.g., vehicle data, real time alerts, news and weather data, driver data, location data, roadside assistance issue data, and/or roadside assistance analysis software applications, etc.), including computer executable instructions for receiving and analyzing various signals or transmissions including location information, vehicle profile, vehicle operating data, other vehicle operating data, and the like, determining a location of a vehicle, determining a cause of an issue, forecasting the breakdown of a vehicle or vehicle type, controlling an amount or type of data transmitted or received, and the like.

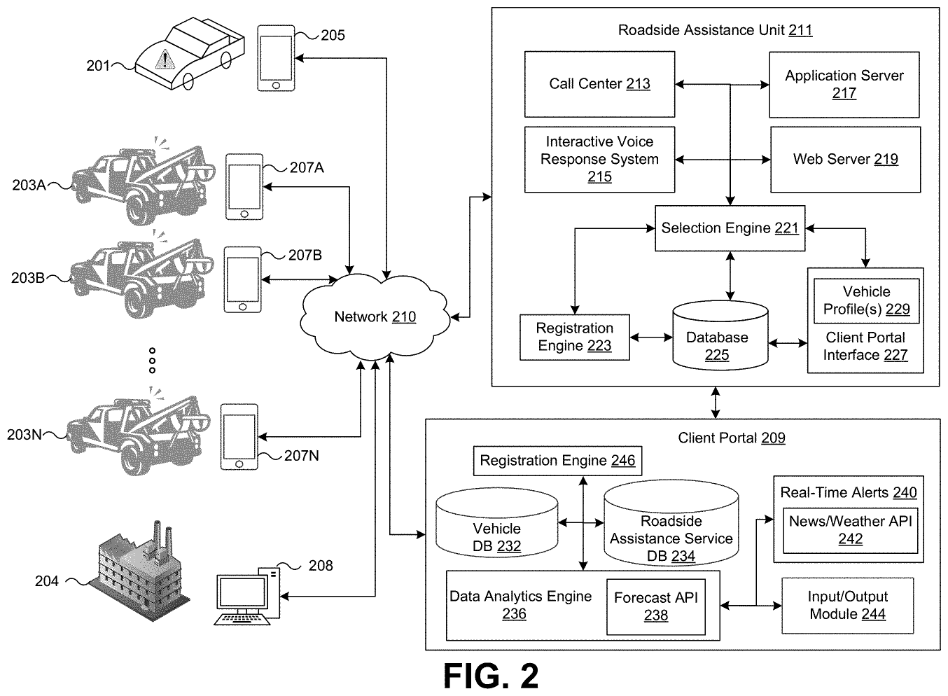

FIG. 2 is a schematic diagram showing an example system for analyzing roadside assistance service of vehicles in real time. The system may comprise one or more user vehicles (e.g., user vehicle 201), one or more service vehicles (e.g., service vehicles 203A-203N), one or more vehicle manufacturer(s) or dealer(s) 204, one or more user computing devices (e.g., user computing device 205), one or more service provider computing devices (e.g., service provider computing devices 207A-207N), one or more computing devices for the vehicle manufacturer or dealer computing system (“client portal” 208) one or more networks (e.g., network 210), one or more roadside assistance units (e.g., roadside assistance unit 211), and one or more client portal servers or computing systems (e.g., “client portal” 209). In some implementation, the vehicle manufacturer and/or dealer computing system (“client portal computing system” or “client portal”) may include a plurality of computing devices (“client portal devices”) 208 that individual vehicle manufacturers and/or dealers may use to perform one or methods and functionalities described in the present disclosure. These computing devices (client portal devices) may be managed by centralized computing system, e.g., as client portal server(s) 209. In other implementations, a vehicle manufacturer and/or dealer may have a standalone computing device 208 that may be similar to and/or identical to the computing system described as client portal server(s) 209. For simplicity, client portal device 208 and client portal server 209 may be collectively referred to as client portal 208-209.

The user vehicle 201 (also referred to as “consumer vehicle”) is shown as a car, but the user vehicle 201 may comprise any type of vehicle, such as a motorcycle, bicycle, scooter, drone (or other automated device), truck, bus, boat, plane, recreational vehicle, helicopter, etc. While only one user vehicle 201 is shown, the system may include multiple user vehicles. A service vehicle of the service vehicles 203A-203N is shown as a tow truck, but the service vehicle may comprise a different type of truck or any other type of vehicle, such as a motorcycle, car, van, bicycle, scooter, drone (or other automated device), bus, boat, plane, helicopter, etc. A service vehicle may also represent a means for delivering parts that a vehicle may need to recover from its breakdown.

The user computing device 205, the service provider computing devices 207A-207N, or the vehicle manufacturer and/or dealer computing device 208 may comprise, for example, a cell phone, smartphone, tablet (e.g., with cellular transceivers), laptop (e.g., communicatively coupled to cellular transceivers), desktop, wearable devices (e.g., smart watches, electronic eye-glasses, etc.), or other types of computing devices configured to communicate with the network 210. The user computing device 205 may be associated with the user vehicle 201, and the service provider computing devices 207A-207N may be respectively associated with the service vehicles 203A-203N. The user computing device 205 and the service provider computing devices 207A-207N may communicate with the network 210 and/or the roadside assistance unit 211, and may directly or indirectly transmit information to the client portal 208-209.

The vehicle user computing device 205 may be associated with a driver or passenger of the user vehicle 201. The service provider computing devices 207A-207N may be respectively associated with a driver or passenger of the service vehicles 203A-203N. The vehicle manufacturer and/or dealer computing device 208, which can also be referred to as “client portal computing device,” may be associated with vehicle manufacturer or dealer 204. Together with the client portal server 209, or as individually, vehicle manufacturer and/or dealer computing device 208 may be referred to as “client portal.” The user computing device 205, the service provider computing devices 207A-207N, or the vehicle manufacturer and/or dealer computing device (“client portal computing device”) 208 may be otherwise embedded respectively in the user vehicle 201, service vehicles 203A-203N, or vehicle manufacturer and/or dealer 204, respectively. The vehicle user computing device 205, the service provider computing devices 207A-207N, and the client portal computing device 208 may be configured in a similar manner as the terminals 141, 151, 161, and 171 of FIG. 1. The user vehicle 201 and the service vehicles 203A-203N may be configured in a similar manner as the terminal 161 of FIG. 1.

The network 210 may be a single network or a collection of multiple connected networks. The network 210 may include one or more of any of various types of information distribution networks, such as a satellite network, a telephone network, a cellular network, a Wi-Fi network, an Ethernet network, an optical fiber network, a coaxial cable network, a hybrid fiber coax network, etc. The network 210 may be a local area network (LAN), a wide area network (WAN), etc. The network 210 may be an Internet Protocol (IP) based network (e.g., the Internet). The network 210 may use a plurality of interconnected communication links to connect the user computing device 205, the service provider computing devices 207A-207N, the client portal computing device 208, the roadside assistance unit 211, and the client portal server 209.

The roadside assistance unit 211 may comprise processes implemented on, for example, a roadside assistance computing device (e.g., as in computing device 101) or other types of computing devices. The roadside assistance unit 211 may comprise one or more call centers (e.g., call center 213), one or more interactive voice response systems (e.g., interactive voice response system 215), one or more application servers (e.g., application server 217), one or more web servers (e.g., web server 219), one or more selection engines (e.g., selection engine 221), one or more registration engines (e.g., registration engine 223), one or more databases (e.g., database 225), and an interface (“client portal interface” 227) for communication with the client portal 208-209. The client portal interface 227 may include a plurality of stored vehicle profile(s) 229, of which one vehicle profile may represent the user vehicle 201. A vehicle profile may include, for example, an identification of an individual vehicle (“vehicle ID”) along with categories under which the individual vehicle may belong (“vehicle type”). Examples of a vehicle ID may include a vehicle identification number (VIN), a license plate identification, engine number, etc. Examples of vehicle type may include a model, a class, a configuration, and/or any other descriptive classification of a vehicle. Data pertaining to one or more of the above-described components (e.g., vehicle profile(s) 229 of client portal interface 227) may be stored in database 225. The components of the roadside assistance unit 211 may be implemented on one or more computing devices.

The roadside assistance unit 211 may be configured to facilitate rendering roadside assistance services to users. The roadside assistance services may comprise, for example, towing, lockouts, fuel delivery, tire change, jump-starts, or other types of services. One or more service providers may provide the roadside assistance services to users. A service provider may be, for example, an individual entity, an individual person, or an organization. A service provider may be associated with a service vehicle (e.g., a service vehicle of the service vehicles 203A-203N), and may be associated with a service provider computing device (e.g., a service provider computing device of the service provider computing devices 207A-207N).

The service providers may be registered with the roadside assistance unit 211 (e.g., using the registration engine 223). The registration engine 223 may be configured to register new service providers to the roadside assistance unit 211, and/or may be configured to manage registered service providers. When a user requests a roadside assistance service, the roadside assistance unit 211 may identify a registered service provider and dispatch the service provider to provide the requested roadside assistance service to the user. Information related to the registered service providers (and/or other service providers) may be stored in the database 225. The database 225 may comprise any type of storage system, such as an ORACLE Database, MySQL, MICROSOFT SQL Server, IBM DB2, etc. In some embodiments, at least some data structures of database 225 may be shared with other computing systems or servers (e.g., vehicle database 232 or roadside assistance service records 234 of client portal 208-209). Alternatively or additionally, database 225 may be periodically updated or periodically update the databases of the other computing systems or servers.

The client portal 209 may comprise processes implemented on, for example, a client portal computing device 208 (e.g., as in computing device 101) or other types of computing devices. In some implementations, the client portal 209 may be identical to the vehicle manufacturer or dealer computing device 208, in which the vehicle manufacturer and/or computing device 208 may also be referred to as client portal 208. Furthermore, client portal 208-209 may be situated or accessible to the vehicle manufacturer or dealer 204. The client portal 209 may comprise one or more registration engines (e.g., registration engine 246); vehicle database 232; roadside assistance service records database (e.g., roadside assistance service records 234); a data analytics engine 236; an application, interface, or module for real-time alerts (e.g., real-time alerts 240); and an input/output module (e.g., input/output module 244) for a user or a personnel of the vehicle manufacturer or dealer 204 (a “client”) to input requests or options, view results, etc. The components of the client portal 209 may be implemented on one or more computing devices.

The client portal 209 may be configured to collect and present real-time information pertaining to roadside assistance services and vehicles receiving roadside assistance services to vehicle manufacturers or dealers 204. Information pertaining to vehicles roadside assistance services may include, but is not limited to, the profile of a vehicle (e.g., vehicle ID and vehicle type (e.g., make, model, year of manufacturer, class, color, vehicle configuration, etc.), the cause of a vehicle's breakdown, the history of the vehicle (including history of any prior breakdowns and roadside assistance services received), the location of the vehicle's breakdown, the user profile of the user of the vehicle (e.g., a user's biographical information, driving history, etc.), quality of the roadside assistance service, user's evaluation of the roadside assistance service, etc. The above-described data may be stored in a vehicle database 232 (e.g., for vehicle profiles and vehicle-specific data) and/or the roadside assistance service records 234 (e.g., for roadside assistance service data). Furthermore, the client portal 209 may be configured to analyze the above-described real-time data, and present in a desired format e.g., using data analytics engine 236. For example, the data may be presented as reports, slides, spreadsheets, graphs, charts, videos, images, or a combination thereof. Various data or analysis of data may be requested by a vehicle manufacturer or dealer 204 (e.g., via an input/output module 244) and outputted to a display of the client portal computing device 208. The data analytics engine 236 may also include an application or module for analyzing the received data to predict future breakdowns of a vehicle, future roadside assistance service demands, and/or locations for potential breakdowns (e.g., forecast API 238). In some implementations, the data analytics engine 236 may also bring real-time data of external events (e.g., via real-time alerts 240) that may impact vehicle performance or roadside assistance, or cause a vehicle breakdown. For example, a news and/or weather application program interface (e.g., news/weather API 242), which can be a part of the real-time alerts 240, may be utilized to obtain real-time data on weather related events; artificial or natural disasters; causes for traffic, vehicle, or road damage; etc.

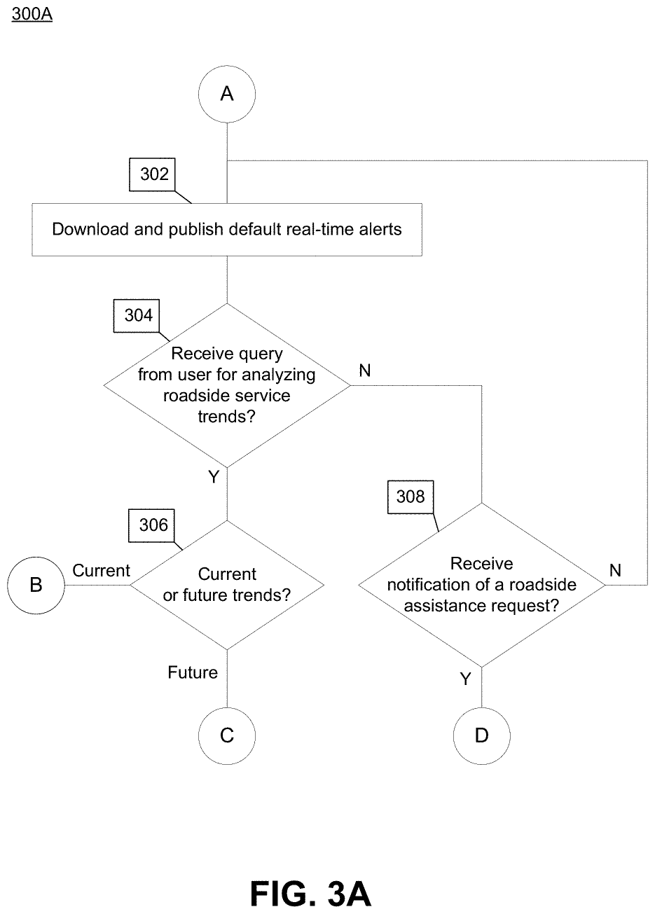

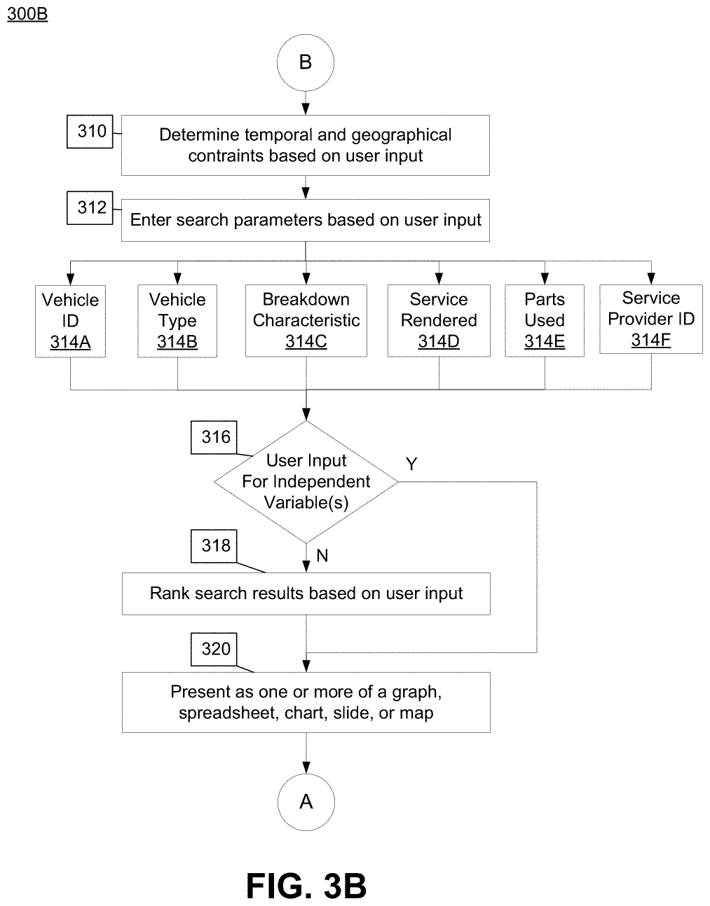

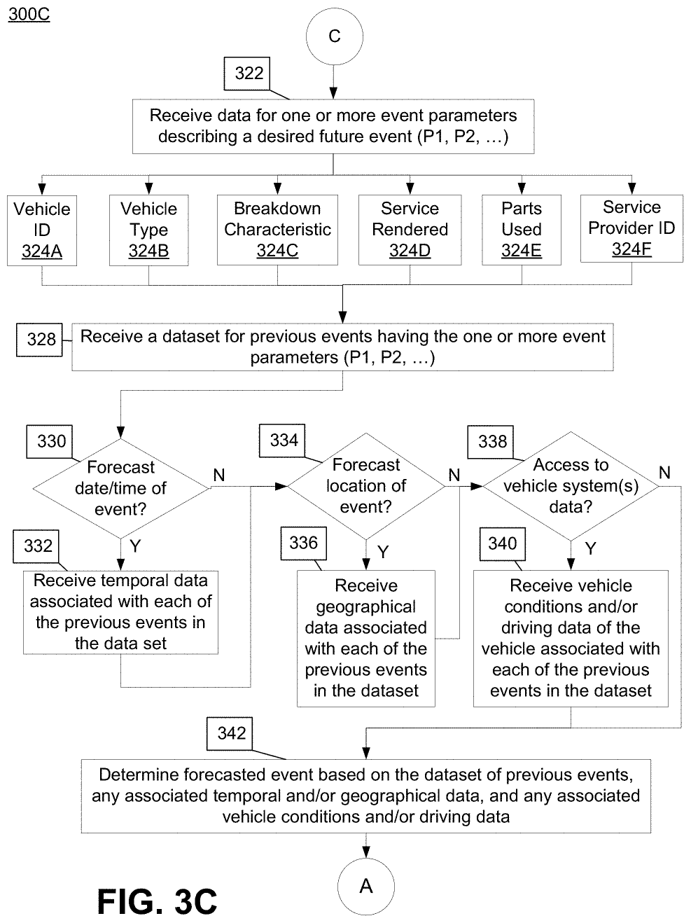

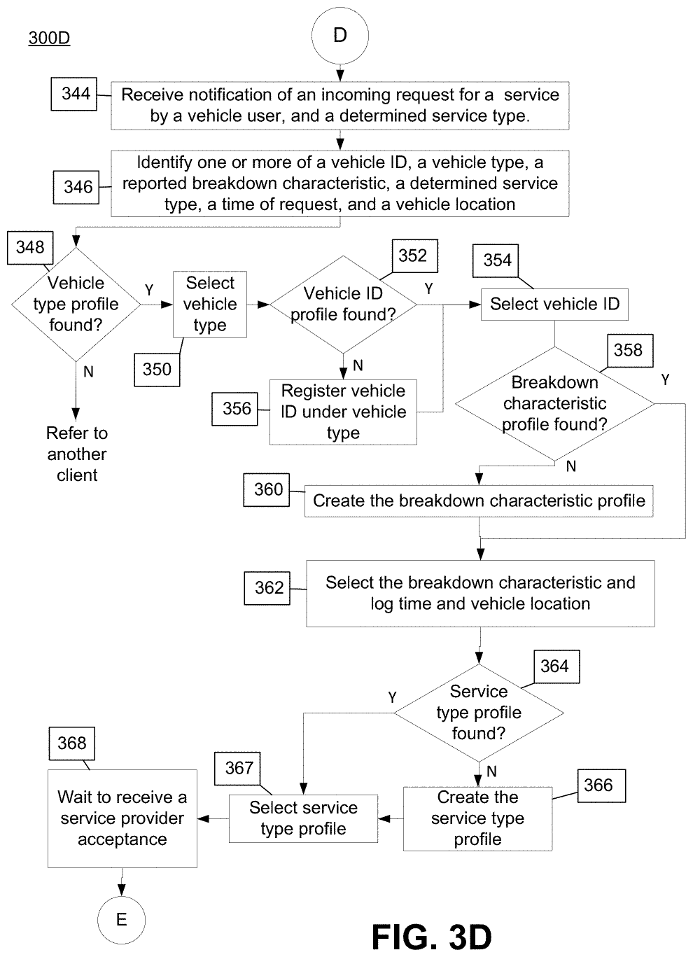

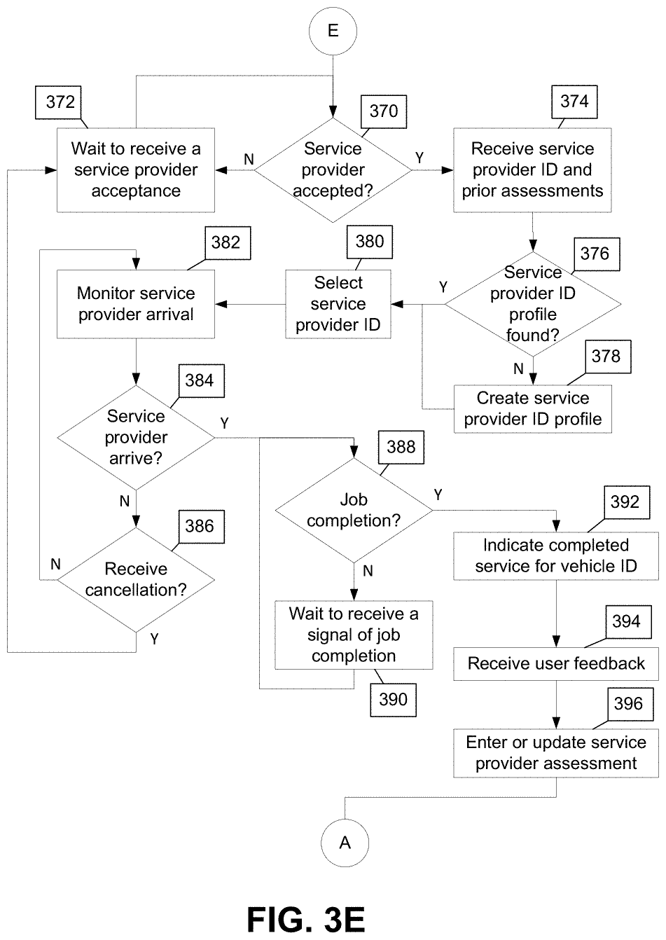

Vehicle users may send requests for roadside assistance services to the roadside assistance unit 211. For example, a vehicle user associated with the user vehicle 201 and the vehicle user computing device 205 may encounter a vehicle malfunction and/or accident. The vehicle user may send, via the vehicle user computing device 205 and the network 210 and to the roadside assistance unit 211, a request for a roadside assistance service to resolve the malfunction and/or accident situation. The roadside assistance unit 211 may select a registered service provider, and may dispatch the service provider to the location of the user to handle the malfunction and/or accident situation. The request may include a vehicle identification and a vehicle location. For example, a user may indicate that his or her vehicle broke down at an identifiable highway intersection, and that the vehicle is of a certain model, make, and color, with a specific license plate. In some implementations, the vehicle's location may be automatically received, e.g., via a telematics system of the vehicle, or via a GPS in the vehicle user device 205 or the vehicle 201. The vehicle can also be identified automatically, e.g., via the telematics system. As will be explained in FIG. 3, the client portal 208-209 and/or the roadside assistance unit 211 may match the vehicle identification to a vehicle profile. For example, the roadside assistance unit 211 may relay information pertaining to the vehicle identification to the client portal 208-209 via the client portal interface 227. Information pertaining to the vehicle's breakdown, location, and any subsequent roadside assistance service may be stored with or linked to the vehicle profile.

Requests for roadside assistance services may be sent to the roadside assistance unit 211 in various manners. For example, a user may make a phone call to the call center 213. The call center 213 may be, for example, an office used for receiving or sending requests by telephone. An agent of the call center 213 may receive and process the user's request for the roadside assistance service. Additionally or alternatively, the user may make a phone call to the interactive voice response system 215. The interactive voice response system 215 may comprise, for example, processes implemented on computing devices that are configured to interact with humans through the use of voice generation and/or speech recognition. The interactive voice response system 215 may recognize and process the user's request for the roadside assistance service.

Additionally or alternatively, the user may enter the roadside assistance service request into an application running on the vehicle user computing device 205. The request may be sent to the application server 217. The application server 217 may comprise, for example, processes implemented on computing devices that are configured to communicate and/or interact with the application running on the vehicle user computing device 205. The application server 217 may receive and process the user's roadside assistance service request, and may relay information to other devices or computing systems (e.g., vehicle profile and roadside assistance information to client portal 208-209). Additionally or alternatively, the user may enter the roadside assistance service request into a web browser (or other types of user interfaces) running on the user computing device 205. The request may be sent to the web server 219, which may be configured to receive and process the request. The user may send the roadside assistance service request via other types of user interfaces and/or other types of media, and the roadside assistance unit 211 may comprise other types of corresponding processes for receiving and processing the user's request.

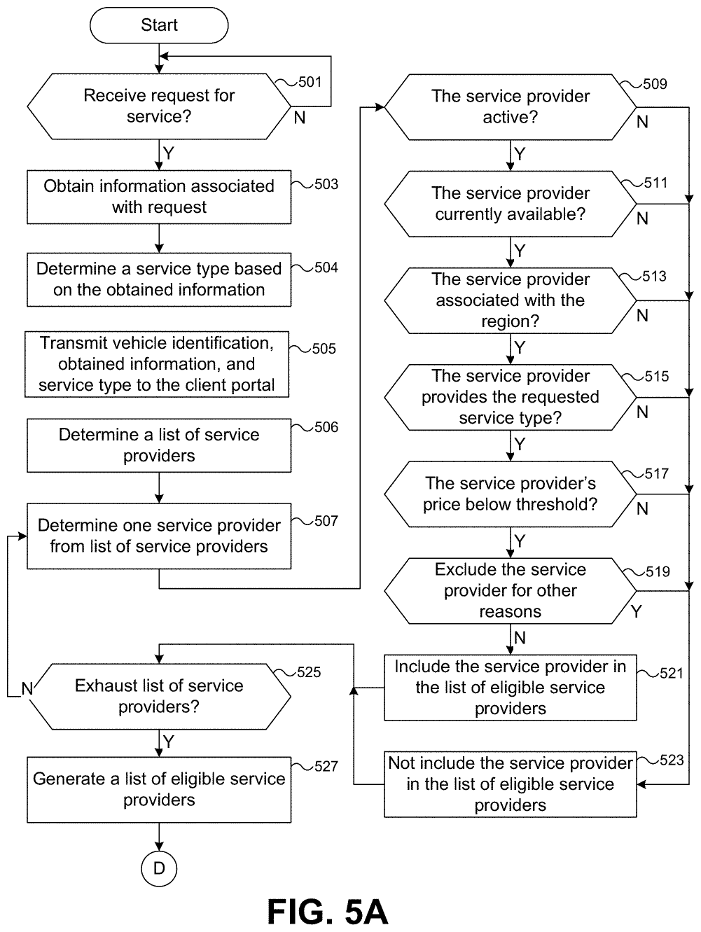

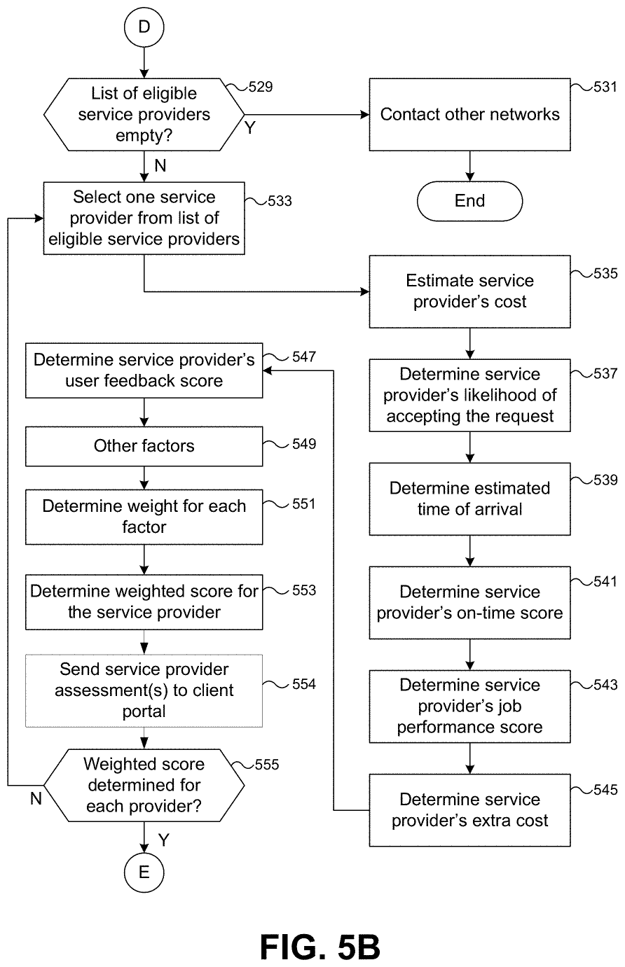

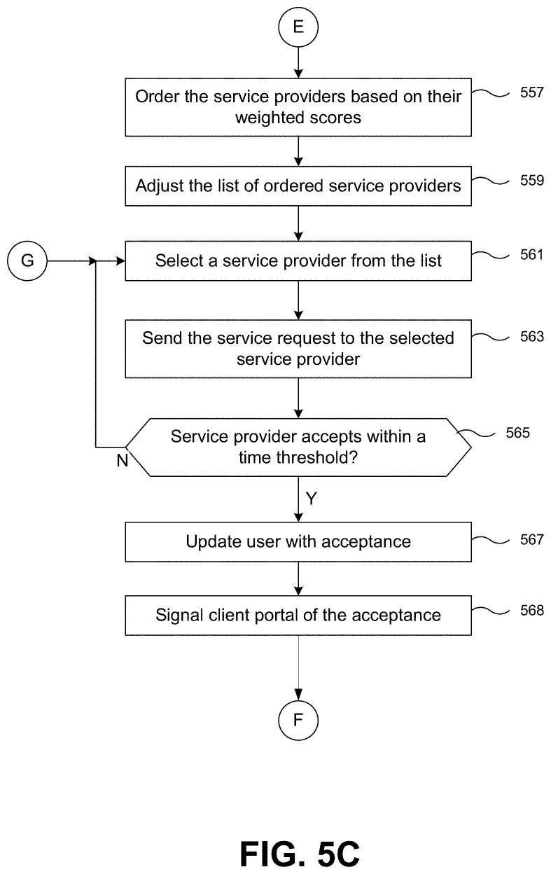

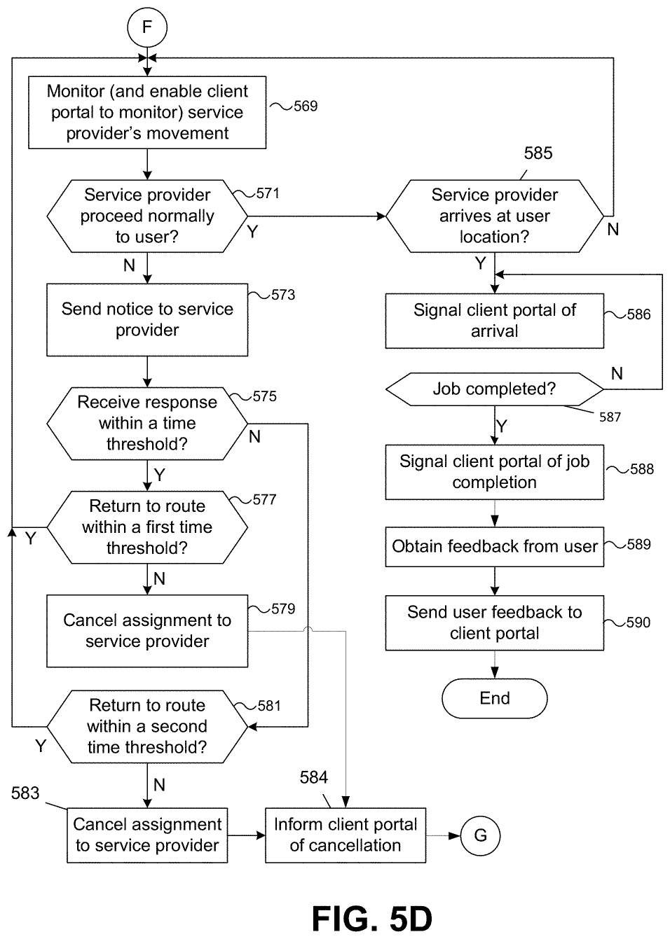

After receiving the user's service request, the selection engine 221 may be configured to select (e.g., in real time) one or more registered service providers based on various factors, for example, in order to select an optimal service provider to render the roadside assistance service to the user. More details regarding processing a service request using the selection engine 221 are discussed below in connection with FIGS. 5A-5D.

At any given time, a number of vehicle users may send requests for roadside assistance services to the roadside assistance unit 211. To satisfy each of these requests, the roadside assistance unit 211 may predict the demand for roadside assistance services in advance, and may attempt to register enough service providers and/or to incentivize registered service providers to supply enough services. The registration engine 223 may, for example, request registered service providers to expand their service coverages (e.g., service regions, work hours, service types provided, etc.). The registration engine 223 may communicate with the selection engine 221, which may select the service providers to which the registration engine 223 may send requests to expand service coverages (e.g., the service providers with best performances). More details regarding managing service provider supply using the selection engine 221 are discussed in connection with FIGS. 5A-5D, and described in U.S. patent application Ser. No. 16/161,737, filed on Oct. 16, 2018, and hereby incorporated in its entirety herein.

For a particular geographical service region, there may be a number of associated service providers, which may provide roadside assistance services to disabled user vehicles in the geographical service region. The quantity of disabled user vehicles in the geographical service region may change with time. For example, there may be more disabled user vehicles in the geographical service region during rush hours than during time periods when the traffic is light. The quantity of service providers, associated with the geographical service region, that are available to provide roadside assistance services to the geographical service region may change with time as well. If the demand for roadside assistance services in the geographical service region is beyond what those service providers may handle, some disabled user vehicles might not get prompt roadside assistance.

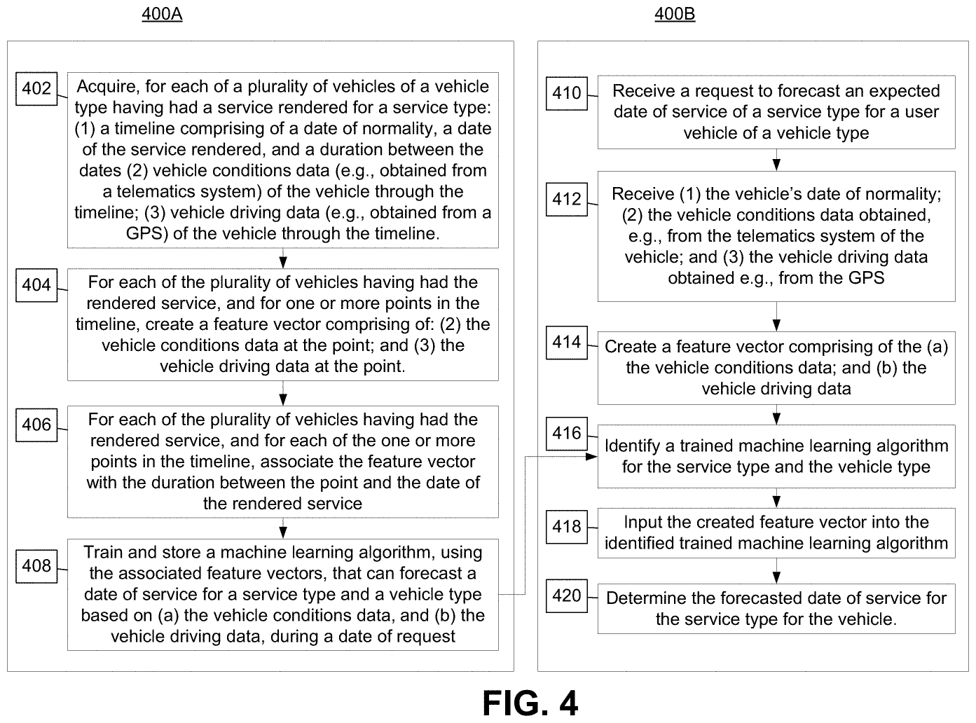

Predicting the demand for roadside assistance services may help alleviate the challenges discussed above. The roadside assistance unit 211 may predict in advance the quantity of service requests from a geographical region during a time period, and may deploy enough service providers to handle the service requests accordingly. Furthermore, the client portal 208-209 may log information of each vehicle requesting roadside assistance service and information of the vehicle's subsequent service. For example, the client portal 208-209 may log information regarding the vehicle's location, breakdown characteristics of the vehicle (e.g., reported reason for the roadside assistance service request), the roadside assistance service provided to the vehicle, and the quality and evaluation of the roadside assistance service. Using this information, the client portal 208-209 may assist clients (e.g., vehicle manufacturers and/or dealers) analyze the breakdown characteristics of each vehicle profile, locations of breakdown (e.g., most common, least common, etc.), types of breakdowns for each vehicle, and/or predict future breakdowns and/or service. Furthermore, the client portal 208-209 may use this information to assist clients in analyzing data pertaining to service providers and their locations. More details regarding the functions performed or facilitated to be performed by the client portal 208-209 are discussed in connection with FIGS. 3A-3E, and FIG. 4.

Service providers associated with a particular geographical service region may provide roadside assistance services of varying qualities. For example, service providers may be different distances away from a disabled user vehicle, and may therefore take different amounts of time to arrive at the disabled user vehicle. The service providers may have varying degrees of user experience and commitments, and may therefore have different tolerances to delays in reaching the disabled user vehicle. Furthermore, the service providers may have varying skill levels to complete the requested roadside assistance services.

The roadside assistance unit 211 (e.g., the registration engine 223) may be configured to rank service providers based on various factors, so that optimal service providers are selected for rendering roadside assistance services. The selection of optimal service providers may be used when the roadside assistance unit 211 deploys service providers to a particular geographical service region and/or time period. The selection of optimal service providers may additionally or alternatively be used when the roadside assistance unit 211 processes a particular roadside assistance service request. Information pertaining to the evaluations and ranking of the service providers may be relayed to the client portal 208-209 and saved into the roadside assistance service records 234. More details regarding selecting optimal service providers are discussed in connection with FIGS. 5A-5D, and described in U.S. patent application no. 16/161,737, filed on Oct. 16, 2018, and hereby incorporated in its entirety herein.

FIGS. 3A-3E illustrate a flowchart showing an example method for analyzing roadside assistance service of vehicles in real time, according to one or more aspects described herein. One or more steps described herein may be performed by the client portal 208-209. Alternatively, or additionally, a client computing system 2209 may be a centralized server or control unit of one or more client portal devices 2208. The client portal devices 208 may be accessed by various vehicle manufacturers, dealers, or businesses (“clients”). The method as depicted in FIGS. 3A-3E may be an iterative loop or cycle.

At a high level, FIG. 3A may describe an exemplary method by which a client portal 208-209 may perform routine operations presenting real-time alerts, and monitoring for any received requests and notifications. Thus, at step 302, the client portal 208-209 (e.g., via its real-time alerts API 240) may download and publish default real-time alerts. For example, the client portal server 209, e.g., via its news/weather API 242 may periodically connect and/or synchronize with an external computing system (e.g., a traffic server, a news station server, a weather station server, etc.). In some aspects, the alerts involve real-time events that may have an effect towards vehicle breakdown or roadside assistance service. Thus, these real-time events may include, for example, weather phenomena (e.g., rain, snow, sleet, hail, ice, storms, flooding, etc.) traffic, accidents, road closures, road detours, road blockage, road construction, criminal activity, police activity, fire, etc. The real-time alerts may be displayed on a user interface display of the client portal 208-209 (e.g., of a client portal device 208) textually (e.g., as a text message or ticker), pictorially (e.g., as a map accompanied with an overlaid illustration of traffic or weather events), audibly, or as a combination thereof. In some aspects, a user may choose to configure how often alerts may be displayed, the mode of delivery, the type of alerts the user wishes to receive, or how often the alerts are updated.

The client portal 208-209 may also periodically monitor whether it has received any requests or notifications. For example, at step 304, the client portal 208-209 may determine whether a query has been received from a user (e.g., client) for analyzing roadside assistance service trends. As will be described further, the query may relate to analyzing one or more parameters of a vehicle or roadside assistance service. The parameters may include, for example, a vehicle identification, vehicle type, breakdown characteristic, a service rendered, a part used or to be used in a roadside assistance service, or a service vehicle identification. The query may be received the client portal computing device 208, which may be accessible to the client. For example, the client may input a request into a client portal 208, e.g., to find out which vehicle types (e.g., vehicle models and classes) have received the most roadside assistance services over the past year. This request may be received as a query by the client portal server 209 at step 304.

If the client portal 208-209 has received a query at step 304, then step 306 may include determining whether the received query pertains to a current or future trend. In at least one example, a current trend may refer to an analysis or determination of current or past event(s) based on received data. For example, a client may wish to know how many of each vehicle type received a roadside assistance service of a tire change in the past year. Furthermore, a future trend may refer to an analysis or determination of future event(s) based on received data. For example, a client may wish to predict which individual vehicles (e.g., as identified by its vehicle ID) would breakdown within three years and may need a roadside assistance service. The prediction may be based on current or past incidents of breakdown of that individual vehicle or the vehicle type of the individual vehicle. As shown in FIG. 3A, if the client portal 208-209 determines that the query pertains to a current trend, the client portal 208-209 may proceed to performing the functions described in FIG. 3B. If the query pertains to a future trend, the client portal 208-209 may proceed to performing the functions described in FIG. 3C.

If the client portal 208-209 has not received a query at step 304, then step 308 may include determining whether the client portal 208-209 has received a notification of a roadside assistance request. In some implementations, the determination of step 304 and step 308 may be performed in parallel. Alternatively, the client portal 208-209 may perform the determination at step 308 prior to the determination at step 304. As will be described in FIGS. 5A-5D, the notification of a roadside assistance request may be received from the roadside assistance unit 211, which may be tasked with managing roadside assistance requests from vehicle users. 201. As shown in FIG. 3A, if the client portal 208-209 determines that it has received a notification of a roadside assistance request, the client portal unit 208-209 may proceed to performing the functions described in FIG. 3D.

Referring now to FIG. 3B, the client portal 208-209 may perform one or more of the following described steps if a query was received for analyzing roadside assistance service trends (e.g., step 304—Yes) and the query concerned current trends (e.g., step 306—Current). At step 310, the client portal 208-209 may determine temporal and/or geographical constraints based on user input. For example, a client user may choose to analyze specific data regarding event(s) that occurred, during, before, or after a specific time (temporal constraint), or within a geographical area (geographical constraint). Regarding the event, the client user may input various search parameters into the client portal 208-209 (e.g., as in step 312). For example, the client user may input the desired search parameters into client computing device 208, and that the input may be detected and processed at the client portal server 209. These search parameters may include, but are not limited to, the vehicle identification 314A, vehicle type 314B, breakdown characteristics 314C, service rendered 314D, parts used 314E, service vehicle ID 314F. The vehicle ID search parameter 314A may refer to an identifier of an individual vehicle. Examples of a vehicle ID may include a vehicle identification number (VIN), a license plate identification, engine number, etc. The vehicle type search parameter 314B may refer to a model, class, configuration, and/or any other descriptive classification of a vehicle. Thus, an exemplary vehicle manufacturer, Toyota, may have among its vehicle types, a Corrolla, a Camry, an Avalon. Each vehicle type may have further classifications and subclassifications, e.g., Corolla Sports Edition, Corolla Hybrid, etc. Furthermore, a vehicle type may be descriptive, e.g., hatchbacks, sedans, minivans, etc. Thus, a vehicle manufacturer may produce a plurality of vehicle types, and each vehicle type may comprise of a plurality of individual vehicles, and the individual vehicles may each have its own vehicle identification. A vehicle profile of an individual vehicle may include its vehicle ID, and the one or more vehicle types under which the individual vehicle may categorically belong.

A breakdown characteristic search parameter 314C may refer to a cause for a vehicle to underperform, malfunction, or breakdown, and which may prompt a service to be rendered. Examples of breakdown characteristics may include. The client portal 208-209 may include, e.g., within its databases, identifications of known breakdown characteristic classifications. Thus, the client portal 208-209 may be able to match an entered description of a breakdown characteristic to, or enable the selection of, a known breakdown characteristic stored in the database.

A service rendered search parameter 314D may refer to a type of service (“service type”) that a service provider may provide to a vehicle having a breakdown characteristic. Examples of service types may include, for example, towing, lockouts, fuel delivery, tire change, oil filter change, tire inflation, jump-starts, brake repair, new brake, or other types of services. There need not be a one to one correspondence between a breakdown characteristic classification and a service type to be rendered.

A service provider may be willing to provide one or more service types (e.g., based on the service provider's equipment, skill set, preference, etc.). In some aspects, a service type may involve equipment or parts. For example, a service type of a tire change may involve a specific tire that is used by a specific vehicle type. The parts used search parameter 314E may refer to a parts or equipment used for such services. Examples of parts used may also involve specific vehicle components, tools, cables, etc.

A service provider ID search parameter 314F may refer to an identifier of an individual vehicle or personnel that is tasked with rendering a service to address a vehicle breakdown. Examples of a service provider ID may include, for example, a VIN, license plate, engine number, or other vehicle identifier or a vehicle belonging to a service provider. Alternatively or additionally, a service provider ID may refer to a name, social security number, a driver license number, an employee identification, or other identifier of a personnel that is tasked with providing service to a vehicle having a breakdown characteristic. When a service provider registers with the roadside assistance unit 211, the service provider may indicate, to the roadside assistance unit 211, roadside assistance service types that the service provider may be willing to handle. The roadside assistance unit 211 may receive the indications of the one or more types of roadside assistance services, and may store the information in the database 225. The database 225 may store a record corresponding to the service provider, and the record may include a data field indicating the one or more types of roadside assistance services that a service provider may be capable of performing.

For a particular service type (e.g., tire change), there may be a number of associated service providers. The registration engine 223 of the roadside assistance unit 211 may predict the demand for the service type, and generate enough supply of service providers for the service type. The registration engine 223 may determine a list of service types, and may predict the demand and generate the supply for each service type in the list.

In some aspects, the user may choose to analyze the effect of one or more search parameter(s) on other search parameter(s). In such aspects, the former search parameter(s) may serve as an independent variable, whereas the latter search parameter(s) may function as dependent variables. For example, the client portal 208-209, at step 316, may determine whether there was a user input for independent variable(s). In some aspects, an independent variable may also include a temporal or geographical constraint. For example, a client may wish to analyze incidents of a breakdown characteristic 314C (e.g., flat tires) of a vehicle type 314B (e.g., Toyota Corolla) over the span of the last five years. In such an example, the time in years may be an independent variable. Likewise, a client may wish to see, on a map, all incidents of a service rendered 314D (e.g., towing) for a vehicle type 314B (e.g., Toyota Corolla) over a geographical region over the past five years. As will be described in step 320, the client may be presented a map of the geographical region with markers denoting where such incidents have taken place. In such an example, each of the plurality of locations along the geographical region may serve as the independent variable.

The client may also choose to not to have an independent variable on which to analyze the search parameter(s) (e.g., Step 316—No). In such an example, the results for the entered search parameters may be arranged according to user input, e.g., ranked from a least to highest or highest to least value, ranked in an ascending or descending alphabetical order, ranked in ascending or descending frequency of occurrence, etc. For example, a client may desire to search all incidents of all service rendered for a specific vehicle identified by its VIN. The client may enter the VIN under the vehicle ID 314A search parameter, and may enable the search for all types of service rendered under the service rendered 314D search parameter. The client portal 208 and/or client portal 208-209 may display results of all incidents of service rendered for that specific individual vehicle (e.g., since manufacture). The client may choose to see these results chronologically, reverse chronologically, or by an ascending or descending alphabetical order of the type of service rendered. The results may be displayed on a user interface of client portal 208. It is expected that at least some arrangements may inevitably present the results based on an independent variable (e.g., time, when the results are presented in a chronological or non-chronological order). The search results may also be arranged based on a default configuration, on a randomized configuration, or simply outputted as each result is processed.

At step 320, the client portal 208-209 and/or the client portal 208 may present the search results as one or more of a graph, a spreadsheet, a chart, a slide, and/or a map. In some aspects, the search result may be based on an inputted or implied independent variable. For example, a graph may display the number of incidents of a brake failure (e.g., a breakdown characteristic 314C) for each model of a car (e.g., a vehicle type 314B). The y-axis of the graph may measure the dependent variable, e.g., the number of incidents of a brake failure, whereas the x-axis of the graph may measure the independent variable, e.g., each model of the car. If the search results cannot be plotted in a two-dimensional form (e.g., they lack an independent variable), the search results may be presented as a spreadsheet, slide, and/or listing based on a selected or predetermined arrangement (e.g., as in step 318). In some aspects, for example, where search results and/or or incidents are desired to be viewed across a geographical region, the client portal 208-209 may present a map of the geographical region. The map may be overlaid with markers denoting incidents having the selected search parameters. The possibilities for the types of presentation are not limited to a graph, spreadsheet, chart, slide, or map. The user interface of the client portal 208 may enable the client to view the search results in one or more of these presentation types. Subsequent to or alongside displaying the desired presentation, the client portal 208-209 and/or client portal 20-8 may resume operations, as described in method 300A of FIG. 3A.

Referring now to FIG. 3C, the client portal 208-209 may perform one or more of the following described steps if a query was received for analyzing roadside assistance service trends (e.g., step 304—Yes) and the query concerned future trends (e.g., step 306—Future). At step 322, the client portal 208-209 may receive data for one or more event parameters (e.g., P1, P2, etc.). Regarding the event parameters, the event being forecasted may relate to vehicle(s) of a vehicle manufacturer or a roadside assistance service of the vehicle(s) of the vehicle manufacturer. The event parameters may include but are not limited to, a vehicle ID 324A, a vehicle type 324B, a breakdown characteristics 324C, a service rendered 324D, a part used 324E, or a service provider ID 324F. The event parameters, as also described in conjunction with FIG. 3B, may refer to descriptive categories by which a client may describe an event. Whereas event parameters 314A-314 may describe current event(s) (e.g., trends), event parameters 324A-324F may describe an event in the future. For example, a client may wish to know when a specific vehicle may would need an oil filter change. The event parameters in this example may be the vehicle ID 324A, e.g., describing the specific vehicle, and a service rendered 324D. In some aspects, data for related event parameters may also be received, e.g., by implication. In the example described, the specific vehicle may be a Toyota Corolla Hybrid, and it may be known that an oil filter change typically results from a contaminated oil filter. Thus, data for the event parameters of vehicle type 324B (e.g., Toyota Corolla Hybrid) and breakdown characteristic 324C (e.g., contaminated oil filter) may also be received.

At step 328, the client portal 208-209 may receive a dataset for previous events having the one or more event parameters (e.g., P1, P2, etc.). For example, in the preceding example, the client wished to forecast a future event of an oil filter change for a specific Toyota Corolla Hybrid vehicle. This involved event parameters of a vehicle ID 324A (the VIN of the specific Toyota Corolla Hybrid), a vehicle type 324B (e.g., the Toyota Corolla Hybrid vehicles), a breakdown characteristic 324C (e.g., oil filter contamination), and a service rendered 324D (e.g., an oil filter change). At step 328, for the discussed example, the client portal 208-209 may receive a dataset for previous incidents of the specific Toyota Corolla Hybrid vehicle, where an oil filter change was performed for a contaminated oil filter. As will be discussed further in this method, the dataset may include the times and/or geographical information concerning these previous incidents. Alternatively or additionally, the dataset may include information about the vehicle's conditions and/or driving data during or preceding each of the previous incidents. It is understood that some event parameters (e.g., vehicle ID 324A) can be subcategories of other event parameters (e.g., vehicle type 324B). In some aspects, receiving a dataset for previous events having the one or more event parameters may involve receiving a dataset for previous events that have the broader event parameters. Thus, in the discussed example, step 328 may involve receiving a dataset for previous incidents of all Toyota Corolla Hybrid vehicles (including the specific Toyota Corolla Hybrid vehicle), where an oil filter change was performed for a contaminated oil filter. Having a broader dataset, e.g., that includes incidents of other Toyota Corolla hybrid vehicles that have had an oil filter change, may result in more robust training that may yield more accurate predictions.

In forecasting an event, a client may desire to know the time and/or location at which the event is to occur, and may input such requests accordingly, e.g., via a user interface of the client portal 208. Thus, at step 330, the client portal 208-209 may determine whether the client has requested to forecast the date and/or time of an event. If that is the case, the client portal 208-209 may, at step 332 receive temporal data associated with each of the previous events in the dataset (e.g., from step 328). For example, in the discussed example of previous incidents where an oil filter change was performed for a contaminated oil filter in the Toyota Corolla Hybrid vehicle, the client portal 208-209 may also receive the dates and/or times for the previous incidents. A client may not necessarily desire to know the time and/or location at which an event is to occur, and may therefore not input such a request (e.g., step 330—No).

At step 334, the client portal 208-209 may determine whether the client has requested to forecast a location of an event. For example, a client may desire to know where the next flat tire is most likely to occur for all vehicle types within a specific geographic region (e.g., a city). This forecasting may be based on prior incidents of flat tires for all vehicle types within the geographic region. If the client has requested to forecast a location of an event, step 336 may include receiving geographical data associated with each of the previous events in the dataset received, e.g., in step 328. Thus, in the last discussed example, the client portal 208-209 may receive the geographic locations (e.g., latitude and longitude, address, road and/or intersection, etc.) for each of the previous incidents where a flat tire has occurred within the geographical region. In some implementations, the geographical and/or temporal information of incidents may be stored in the roadside service records database 234 of the client portal 208-209.

Additionally, or if the client has not requested to forecast the location of an event, the client portal 208-209 may determine, at step 338, whether there is access to vehicle system(s) data. In some implementations, there may be access by way of establishing a connection with the vehicle system(s) of one or more vehicle(s). The vehicle system(s) may refer to a telematics system, global positioning system (GPS), a sensor (e.g., accelerometer, gyrometer, camera, barometer, odometer, etc.) and the like, which may be used within, or exterior to a vehicle. In some implementations, data gathered by these sensors may be stored in a database, which can be accessed by the client portal 208-209. The vehicle system(s) data may include, for example, vehicle conditions and/or driving data.

Vehicle conditions data may involve a measurement of performance, health, durability, aging, aesthetic appeal, or wear for a specific vehicle feature or aspect. Thus, vehicle conditions data may measure the conditions of a vehicle's exterior, interior, mechanical, software, or hardware, which may be prone to aging, rust, damages, errors, etc. For example, vehicle conditions data may include, e.g., tires, mileage, any part of the vehicle's body (exterior and interior), engine performance, oil filter, any machinery of the vehicle, safety features, car seats, vehicle entertainment system, lighting, autopilot performance, etc.

Vehicle driving data may refer to data regarding how and where a vehicle has been driven. For example, a global positioning system (GPS) of a vehicle or user device of the vehicle user may provide the routes that the vehicle has driven through, and external sources (e.g., traffic and transportation computing systems) may provide data on the road conditions at the time when the vehicle was driven. The vehicle driving data may also include, for example, data pertaining to the vehicle user, e.g., records of accidents, traffic incidents, driving habits, etc., which may be obtained from the computing systems of a motor vehicles department or other governmental source. Thus, determining whether the client portal 208-209 has access to the vehicle driving data may involve determining whether the client portal 208-209 can connect to these computing systems to retrieve one or more of the above-described data.

If the client portal 208-209 has access, step 340 may include receiving the vehicle conditions and/or driving data of the vehicle associated with each of the previous events in the dataset. For example, for each previous incident at which a Toyota Corolla Hybrid has undergone an oil filter change, the client portal 208-209 may retrieve information to the mileage that the vehicle has driven so far, maintenance history of the vehicle, routes driven, and an assessment of vehicle conditions measured by vehicle sensors up until the date that the oil filter change occurred. The vehicle conditions and/or driving data may be stored in vehicle database 232, e.g., as part of the vehicle profile. The registration engine 246 may map each vehicle profile stored in vehicle database 232, which may include the vehicle conditions and/or driving data of the vehicle, to information of the previous events of the vehicle (including geographical and temporal information) stored in the roadside service records database 234.

At step 342, the client portal 208-209 may determine the forecasted event (that a client had requested). The forecasting may be based on the dataset of the previous events (e.g., from step 328), any associated temporal and/or geographical data associated with each of the previous events (e.g., from steps 332 and 336), and any vehicle conditions and/or driving data of the vehicle associated with each of the previous events (e.g., from step 340). In some implementations, step 342 may involve training a machine learning algorithm or other supervised learning tool based on the dataset of previous events, and associated temporal, geographical, and vehicle system(s) data. The forecasting may be performed by forecast API 238. Method 400, as depicted in FIG. 4 describes at least one example of the training and implementation of a machine learning algorithm to forecast an event that a client may desire to be forecasted. Details of the forecasted event may be displayed to the client, via a user interface of the client portal 208. Like step 320 of method 300B, the details of the forecasted event may be presented according to a medium desired by the client (e.g., graph, spreadsheet, chart, slide, map, etc.). Subsequent to or alongside displaying the desired presentation, the client portal 208-209 may resume operations, as described in method 300A of FIG. 3A.

Referring now to FIG. 3D, the client portal 208-209 may perform one or more of the following described steps if a notification of a roadside assistance request was received (e.g., step 308—Yes). The notification may be received from the roadside assistance unit 211, based on a request sent by a vehicle user (e.g., via vehicle user device 205). In some aspects, the notification may be received directly from the vehicle user. As will be described in FIG. 5, the roadside assistance unit 211 may process the request and determine a service type that is appropriate for the user based on the request. In some implementations, the request may include one or more of an identification of the vehicle of the vehicle user (“vehicle ID”), an identification of the vehicle type (e.g., make, model, class, category of vehicle, etc.), a reported cause for the request pertaining to a deficiency or malfunctioning of the vehicle (“breakdown characteristic”), a date and/or time of the request, and the location of the vehicle. Methods 300D-300E, as depicted in FIGS. 3D-3E, may describe methods for obtaining real-time information from the activities performed by the roadside assistance unit 211 in method 500 as depicted FIG. 5. Furthermore, methods 300D-300E describe an organization of the obtained real-time information in a meaningfully novel and nonobvious way to analyze current and future trends.

Thus, at step 344, the client portal 208-209 may receive notification of an incoming request for a service by a vehicle user, and the service type determined by the roadside assistance unit 211. At step 346, the client portal 208-209 (e.g., via registration engine 246) may identify one or more of the vehicle ID, vehicle type, the reported breakdown characteristic, the determined service type, the date and/or time of request, and the vehicle location. Information of these identified parameters may be stored within the vehicle database 232 and/or roadside service records 234 in subsequent steps. Data structures within either database may be mapped, linked, or associated as will be described below. In some implementations, a different number of, or a single database may be used.

As described above, a client may be, for example, a vehicle manufacturer and/or dealer, which may benefit from the client portal described herein. As a vehicle manufacturer and/or dealer, the client may have within its registry or records, a plurality of vehicle types that the client manufactures or sells. For example, a vehicle manufacturer like Toyota may have a plurality of vehicle types. The vehicle types may include, models (e.g., Avalon, Corolla, Camry, etc.), editions (Sports, Hybrid, SUV, Luxury, etc.), colors, and vehicle structures for each model (e.g., sedans, minivans, hatchbacks, etc.). The registry or records may be a data structure within the memory of the client portal 208-209. Thus, at step 348, the client portal 208-209 may determine if the vehicle type, identified in step 346, is found within the database. If it is not found, the vehicle type may not necessarily belong to the client. For example, if the vehicle type of a Model S, which is typically manufactured by the vehicle manufacturer, Tesla, then a client like Toyota may not find the vehicle type of Model S in the memory of the client portal. As such, the received notification from step 344 and any subsequent information received regarding the Model S (e.g., service request) may be forwarded to a client that manufacturers or sells Model S (e.g., Tesla Inc.). However, if the client does recognize the vehicle type as being one of its own (e.g., Step 348—Yes), then the client portal 208-209 may select the vehicle type from its database of vehicle types. It is contemplated that the client portal 208-209 may store information about each of the client's vehicle types, including the plurality of individual vehicles sold or manufactured for each vehicle type.

While the client portal 208-209 may recognize a vehicle type as belonging to the client (e.g., as a vehicle manufacturer and/or dealer), the client portal 208-209 may not necessarily have a record of the specific vehicle. Thus, at step 352, the client portal 208-209 may search its database (e.g., vehicle database 232) to see if the vehicle ID of the vehicle can be found. If the vehicle ID is not found, the client portal 208-209 may register the vehicle ID (e.g., as in step 356). For example, the client portal 208-209 may recognize, from the received information, xxxxxxxxxxxxx, as being a vehicle ID. However, the client portal 208-209 may not have a record of xxxxxxxxxxxxx in its memory of stored vehicle IDs. The vehicle ID may be stored in a date structure associated with the vehicle type. Subsequently, or if the vehicle ID is found, the client portal 208-209 may select the vehicle ID (e.g., as in step 354) to store further information.

At step 358, the client portal 208-209 may also determine whether it has a stored profile for the breakdown characteristic (e.g., within a vehicle profile(s) stored in the vehicle database 232 or as stored within the roadside service records database 234). For example, other vehicles or vehicle types may have also undergone the same breakdown characteristic (e.g., flat tire) in the past, and the client portal 208-209 may have a description for that breakdown characteristic. If it does not (e.g., the client portal has never received a notification in the past of the breakdown characteristic suffered by one of the client's vehicles), the client portal 208-209 may create the breakdown characteristic profile. In some implementations, the client portal 208-209 may have a repository of profiles for well-known breakdown characteristics (e.g., engine failure, flat tire, broken headlights, brake failure, contaminated oil filter, etc.), which may be updated and/or added to. Subsequently, or if the breakdown characteristic was found in step 358, the client portal 208-209 may select the breakdown characteristic (e.g., step 362), to add further information. For example, the client portal 208-209 may log date, time, and vehicle location for the reported breakdown characteristic of the vehicle (e.g., as in step 362). In some aspects, the data structure for a breakdown characteristic may include a data structure for the vehicle IDs of individual vehicles that have suffered the breakdown characteristic. In other aspects, the data structure for a vehicle ID may include or be associated with data structures for various breakdown characteristics suffered by the vehicle representative of the vehicle ID in its history. In further aspects, the data structure of the breakdown characteristic, vehicle ID, and vehicle type may be interlinked, so that there is no set hierarchy.

The client portal 208-209 may also determine whether it has, within its memory (e.g., vehicle database 232, roadside assistance service database 234, etc.), a profile for the determined service type (e.g., step 364). As described above, the roadside assistance unit 211 can determine a service type that may be appropriate to fix the breakdown characteristic suffered by the vehicle. If not found, the client portal 208-209 may create a service type profile. The service type profile may be created within or be associated with the breakdown characteristic profile.

Subsequently, or if the service type profile is found, the client portal 208-209 may select the service type profile (e.g., step 367), for example, to enter further information. As will be discussed in correspondence with FIGS. 5A-5D, the roadside assistance unit 211 may determine an appropriate service provider to service the vehicle having the breakdown characteristic. However, the service provider (e.g., a service vehicle or personnel) may need to confirm acceptance of the task to service the vehicle having the breakdown characteristic. Thus, at step 368, the client portal 208-209 may wait to receive an acceptance of the service provider to perform the task. The acceptance may be received directly from the service provider and/or from the roadside assistance unit 211.

Continuing to FIG. 3E, the client portal may periodically determine whether the service provider has accepted the task to service the vehicle, e.g., by checking to see whether the client portal 208-209 has received the acceptance. If not, the client portal 208-209 may continue to wait to receive the service provider acceptance (e.g., step 372). After a service provider has accepted, the client portal 208-209 may receive a service provider ID. A service provider ID may identify the service provider (a service vehicle and/or personnel), e.g., for purposes of documenting and storing information associated with the service provider. Examples of a service provider ID may include but are not limited to, a VIN, a license plate, an engine number, or other vehicle identifier of a vehicle belonging to a service provider. Alternatively or additionally, a service provider ID may refer to a name, social security number, a driver license number, an employee identification, or other identifier of a personnel that is tasked with providing service to a vehicle having a breakdown characteristic. Furthermore, the client portal 208-209 may receive assessments of the service provider's past performances (“prior assessments”). For example, prior evaluations of the service provider's performance by the vehicle user or the roadside assistance unit 211 may be received.

At step 376, the client portal 208-209 may determine whether there is a stored profile for the service provider ID. For example, there may be a stored profile based on an earlier vehicle breakdown incident for which the service provider having the service provider ID could have provided service. In some aspects, the client portal 208-209 may have a repository of stored service provider ID profiles based on common service providers in a network or geographic region. The repository may be stored within roadside service records 234. Service provider ID profiles may be linked or otherwise associated with the vehicle profiles (e.g., vehicle ID, vehicle type, etc.) of the vehicles that a service provider represented by the service provider ID has serviced. If the service provider ID profile is not found within the repository, the client portal 208-209 may create the service provider ID profile. The service provider ID profile may be associated with the data structures for the profiles for the service type and/or the breakdown characteristic, for example, if the service provider having the service provider ID provides the service type that treats the breakdown characteristic.

Subsequently, or if the service provider ID profile is found, the client portal 208-209 may select the service provider ID profile (e.g., at step 380), for example, to enter further information.

As will be discussed in conjunction with FIGS. 5A-5D, after a designated service provider has accepted the request to service the vehicle, the roadside assistance unit 211 may monitor the service provider's journey to and/or arrival at the location of the vehicle having the breakdown characteristic. One or both of the roadside assistance unit 211 and the client portal 208-209 may monitor the service provider arrival, e.g., via establishing a connection with the telematics system of the vehicle. In some implementations, the service provider ID may be used to set up a wireless connection with the telematics system of the vehicle. In other implementations, the roadside assistance unit 211 may periodically update the client portal 208-209 of the service provider's journey to the vehicle location, or of the service provider's arrival at the vehicle location. Thus, step 382 may involve monitoring the service provider's arrival. If the service provider has not arrived, e.g., after a predetermined time or after predetermined time increments, the client portal 208-209 may determine whether it has received any notification of a cancellation of the service provider's acceptance. The notification may be received from the roadside assistance unit 230 and/or the service provider. As will be discussed in conjunction with FIG. 5D, the roadside assistance unit 211 may cancel an assignment to a service provider if the service provider delays reaching the location of the vehicle needing service, or does not respond to notice(s) sent by the roadside assistance unit 211 within a threshold time. Thus, if the client portal 208-209 received notification of the cancellation, the client portal 208-209 may again wait to receive a notification of an acceptance of a service provider to attend to the vehicle having the breakdown (e.g., step 372). However, if the client portal 208-209 has not yet received a notification of a cancellation, the client portal 208-209 may continue to monitor the service provider's arrival (e.g., step 382).

After the service provider has arrived (e.g., Step 384—Yes), the service provider may attend to fixing the breakdown characteristic of the vehicle requesting service, by performing the determined service type. However, it is to be appreciated that the service provider may make an ad-hoc decision to perform another service type or to treat a different and/or previously unreported breakdown characteristic of the vehicle, as may be expected.

At step 388, the client portal 208-209 may determine whether the service provider has completed the job, e.g., performing the service to the vehicle to treat its breakdown characteristic. This determination may be based on the receipt of a notification from the roadside assistance unit 211, the service provider, and/or the vehicle user, that the job has been completed. If the job has not been completed, the client portal 208-209 may continue to wait to receive a signal (e.g., notification) of the job completion (e.g., step 390).

After the service provider has completed the job, or the client portal 208-209 has received notification of the job completion, the client portal 208-209 may indicated the completed service in a data structure associated with the vehicle ID profile. In some aspects, the indication may include a time of completion and may be associated with the data structure of the profile for the service provider ID, the service type, the breakdown characteristic, and/or the vehicle type.

At step 394, the client portal unit may receive user feedback pertaining to the service provider. For example, the feedback may involve an assessment of the service provider's timeliness, efficiency at fixing the breakdown characteristic, ability to treat the breakdown characteristic or perform the service requested or determined, and professionalism. The user feedback may be received from the vehicle user (e.g., via user device 205) and/or the roadside assistance unit 211. The client portal 208-209 may enter and/or update the service provider assessment based on the received user feedback (e.g., as in step 396). The service provider assessment may be associated with the data structure of the profile of the service provider ID. The updated service provider assessment may be used to determine a weighted score for the service provider, as will be discussed in FIGS. 5A-5D. In some implementations, the weighted score for the service provider may be used to assign service provider to a vehicle needing service, as described in U.S. patent application Ser. No. 16/161,737, filed on Oct. 16, 2018, and hereby incorporated in its entirety herein. As discussed above, the client portal 208-209 may receive information from the vehicle user, service provider, or the roadside assistance unit 211 to store in the data structure(s) of the profiles of various parameters (e.g., vehicle ID, vehicle type, breakdown characteristic, service type, service provider ID, etc.). This information may be retrieved by the processes described above to analyze current trends or to forecast future events.

FIG. 4 illustrates a flowchart showing an example method for predicting a future roadside assistance service parameter, in accordance with one or more aspects described herein. Specifically, FIG. 4 illustrates an example method for forecasting a date of service of a service type (e.g., tire change, oil filter change, etc.) for a vehicle of a vehicle type. The method may forecast based on vehicle conditions and driving data as of the date the forecasting has been requested. However, other roadside parameters (e.g., a time and/or location of a vehicle breakdown having a breakdown characteristic) can also be predicted using the steps recited herein.

The method depicted in FIG. 4 may include a training method 400A for training one or more machine learning algorithms based on, e.g.: the vehicle conditions data; vehicle driving data; and a timeline comprising of a date of normality, a date of the rendered service, and the duration between these dates. The method depicted in FIG. 4 may also include a production method 400B for using the trained machine learning algorithm to determine a forecasted date of service for a vehicle. Methods 400A and 400B may be performed by the client portal 208-209. Alternatively, the training method (e.g., 400A) may be performed by an external server or computing system (e.g., an AI or research lab). In some implementations, a trained machine learning algorithm may be retrieved by the client portal 208-209 to determine a forecasted date of service via method 400B.

Thus, step 402 may include acquiring, for each of a plurality of vehicles of a vehicle type having had a service rendered for a service type, a training data set for the machine learning algorithm to be trained. The training data set may include, but is not limited to: (1) a timeline comprising of a date of normality, a date of the service rendered, and a duration between the dates (2) vehicle conditions data of the vehicle through the timeline; (3) vehicle driving data of the vehicle through the timeline. A date of normality may refer to the last date preceding the date of the rendered service at which the vehicle functioned normally. At the date of normality, the vehicle would function such that a service of the service type being rendered during the date of the rendered service would not have been necessary during the date of normality. For example, the date of normality for a relatively new vehicle that just received service of a tire change may be the date of manufacturer of the vehicle. A date of normality for an older vehicle that has repeatedly received the same service (e.g., an oil filter change) over its long history may be the last date of service (e.g., the last time the vehicle's oil filter had been changed prior to the most recent oil filter change), which precedes the most current date of service.

Vehicle conditions data may include measurements of performance, health, durability, aging, aesthetic appeal, or wear for a specific vehicle feature or aspect. Thus, vehicle conditions data may measure the conditions of a vehicle's exterior, interior, mechanical, software, or hardware, which may be prone to aging, rust, damages, errors, etc. For example, vehicle conditions data may include, e.g., tires, mileage, any part of the vehicle's body (exterior and interior), engine performance, oil filter, any machinery of the vehicle, safety features, car seats, vehicle entertainment system, lighting, autopilot performance, etc. In some implementations, the vehicle conditions data may be obtained by establishing a connection with the telematics system or server of the vehicle. For example, the client portal 208-209 and/or an external system tasked to train the machine learning algorithm in method 400A may retrieve, from the telematics system, a record of measurements from various vehicle sensors over a duration of time (e.g., from the date of normality to the date of the rendered service). The sensors from which data are obtained may be the ones that are most relevant for the service that was eventually rendered to the vehicle. Thus, for the service type of an oil filter change, data may be obtained for sensors measuring oil filter levels, engine temperature, and pressure throughout the duration of time.

Vehicle driving data may include data regarding how and where a vehicle has been driven. In some implementations, a global positioning system (GPS) of a vehicle or user device of the vehicle user may provide the routes that the vehicle has driven through. Furthermore, external systems or servers (e.g., traffic and transportation computing systems) may provide data on the road conditions at the time when the vehicle was driven. The vehicle driving data may also include, for example, data pertaining to the vehicle user, e.g., records of accidents, traffic incidents, driving habits, etc., which may be obtained from the computing systems of a motor vehicles department or other governmental source. With respect to acquiring useful training data in step 402, vehicle driving data may be obtained of the vehicle during the duration between the date of normality and the date of the rendered service (e.g., the routes that the vehicle has traversed, the conditions of the roads, an assessment of the wear and tear that the conditions of the road may have posed to the vehicle, etc.)

Step 404 may involve creating feature vectors for each of the plurality of vehicles having the rendered service, and for one or more points in the timeline. Each point in the timeline may be, for example, a date and/or time between the date of normality and the date of the rendered service. The feature vector may include, for example: the vehicle conditions data at, or up until, the point; and the vehicle driving data at, or up until, the point. Each of these features may be quantified, and/or expressed as mathematical functions. At step 406, the feature vectors may be associated with the duration between the point and the date of the rendered service. The duration of time between the point and the date of the rendered service may represent how far ahead in time, from the date and/or time represented by the point, the vehicle received the service. As discussed above, the point may be one of many dates and/or times along a timeline between the date of normality and the date of the rendered service. As there may be a plurality of vehicles having had the rendered service and a plurality of points representing dates and/or times between the date of normality and the date of the rendered service, there may be many associated feature vectors.

Step 408 may include training a machine learning algorithm using the associated feature vectors. The resulting machine learning algorithm would be one that can forecast a date of service for a service type and a vehicle type based on (a) the vehicle conditions data, and (b) the vehicle driving data, during a date of request. The training of the machine learning algorithm involves supervised learning between a domain (e.g., the feature vectors) and a range (e.g., the duration of time between the points and the date of the service rendered). Examples of machine learning algorithms may include, but are not limited to multi-layer perceptron, neural networks, support vector machines, linear regression, logistic regression, decision tree learning, or a combination thereof.

The training method 400A may then save the results of the machine learning algorithm, including feature weights, in a memory of client portal 208-209 and/or client portal 208. Alternatively or additionally, an external computing system or server (e.g., a research lab) may save the trained machine learning algorithm, which can be retrieved to be used by the client portal 208-209 for production method 400B. The stored feature weights may define the extent to which vehicle conditions data and vehicle driving data may affect the time it takes for a vehicle to need a specific service.

Referring to production method 400B, step 410 may include receiving a request to forecast an expected date of service of a service type for a user vehicle of a vehicle type. The request may be inputted by the client user into the client portal 208 via a user interface. For example, as explained in conjunction with FIG. 3C above, the client may choose to forecast an event by selecting the event parameters of a service type 324D, a vehicle type 324B, and a vehicle ID 324A representing the user vehicle, and input a request for the next forecasted date of the event described by the event parameters.

At step 412, the client portal 208-209 may receive (1) the vehicle's date of normality; and features that could be used in a trained machine learning algorithm to predict the expected date at which the vehicle would be receive a service. The features may include, for example, the vehicle conditions data at, or up to, the date and/or time of the received request, and the vehicle driving data at, or up to, the date and/or time of the received request. Step 414 may include creating a feature vector comprising of these features (e.g., the vehicle conditions data and the vehicle driving data).

At step 416, the client portal 208-209 may identify a trained machine learning algorithm for the service type and the vehicle type. For example, the client portal 208-209 may search within its databases to retrieve a trained machine learning algorithm for predicting the event that is requested by the client. In some implementations, the client portal 208-209 may identify a trained machine learning algorithm from external computing systems and/or servers. After identification and retrieval, the client portal 208-209 may input the created feature vector into the identified trained machine learning algorithm (e.g. as in step 418). Based on the training in method 400A, the trained machine learning algorithm may output the duration of time until the vehicle needs or receives service, from the date and/or time of the client's request. From this duration, the client portal 208-209 may determine the forecasted date of service for the service type for the vehicle by adding the duration of time to the date and/or time of the client's request (e.g., as in step 420). In some implementations, the training method 400A and/or the production method 400B may be performed by the forecast API 238 of the client portal 208-209.

FIGS. 5A-5D illustrate a flowchart showing an example method for processing a request for a roadside assistance service in accordance with one or more aspects described herein. The method may be performed, for example, by the system as described in connection with FIG. 2 (e.g., the client portal 208-209 (e.g., client portal device 208 and/or client portal server 209), the roadside assistance unit 211, the user computing device 205, and/or the service provider computing devices 207A-207N). The steps of the example method may be described as being performed by particular components and/or computing devices for the sake of simplicity, but the steps may be performed by any computing device. One or more steps of FIGS. 5A-5D may be performed by executing program(s) and/or by operating particularly configured computing device(s). As a result of the method of FIGS. 5A-5D, vehicle manufacturers, dealers, and other users of the described technology (e.g., “clients”) may receive real-time information relating to vehicles (e.g., the user vehicle 201) needing roadside assistance service, including, for example, the types of service most requested by a specific vehicle type, the geographical and/or temporal characteristics of vehicle breakdowns, and weather and/or traffic impacting vehicle breakdown and roadside assistance service, and forecasting of future vehicle breakdowns and roadside assistance service. The real time information may be stored, for example in vehicle database 232 and/or roadside assistance service database 234 of client portal 208-209. The real-time information may be analyzed and used to output current trends (e.g., via data analytics engine 236) and/or predict future trends (e.g., via forecast API 238), as was described above, in conjunction with FIGS. 3A-3E.

With reference to FIG. 5A, in step 501, the system (e.g., the roadside assistance unit 211) may determine whether a request for a roadside assistance service is received. As described in connection with FIG. 2, a service request may be received from a user computing device in various manners, such as via the call center 213, the interactive voice response system 215, the application server 217, the web server 219, etc. If the roadside assistance unit 211 determines that a service request is received, the method may proceed to step 503. Otherwise, the roadside assistance unit 211 may keep listening to the incoming traffic to determine if a service request is indicated in the incoming traffic. In some aspects, the roadside assistance unit 211 may signal the client portal 208-209 that a request for a roadside assistance service is received. Thereafter, the client portal 208 and/or client portal 208-209 may open and/or create a data structure to enter subsequent information that is received pertaining to this request.

In step 503, the roadside assistance unit 211 and/or client portal 208-209 may obtain information associated with the received service request. For example, the roadside assistance unit 211 may perform the functions of receiving requests for, and facilitating, a roadside assistance, but may relay information pertaining to the request and the roadside assistance to the client portal 208-209 to analyze. The roadside assistance unit 211 may determine the location of the disabled user vehicle (e.g., the user vehicle 201). The location information (e.g., Global Positioning System (GPS) coordinates) of the disabled user vehicle may be received with the service request. Alternatively or additionally, the vehicle user may indicate the vehicle location (e.g., street intersection) on a user device, which may be received by the roadside assistance unit 211 and/or client portal 208-209, e.g., via a call center. The roadside assistance unit 211 may also determine the type of roadside assistance service requested. For example, the user may enter, in an application running on a user computing device, the type of service requested, which may be sent to the roadside assistance unit 211, and which may be conveyed to the client portal 208-209. Additionally or alternatively, the user may indicate, in the service request, problems that the user is experiencing (e.g., the “breakdown characteristics”), and the roadside assistance unit 211 may, at step 504, determine the proper service needed. For example, the user may report a breakdown characteristic of a flat tire, and the roadside assistance unit 211 may determine, at step 504, that the appropriate service needed is a tire change. Using the obtained information, the system (e.g., the selection engine 221) may determine, based on various criteria, a list of eligible service providers for providing the requested service to the user in step 506, as will be explained below.

In implementations where a computing system distinct from the client portal (e.g., a roadside assistance unit or its call center) performs steps 501 through step 504, step 505 may include transmitting various information associated with the vehicle or the request over to the client portal 208-209 to perform methods described herein. For example, step 505 may include transmitting at least the vehicle identification (VIN, make, model, year and/or date of manufacturer, class, etc.), the obtained information (breakdown characteristics, reasons for service, etc.), and the determined service type to the client portal 208-209.

In step 506, the selection engine 221 may determine a list of service providers, from which the list of eligible service providers may be selected. The database 225 may store a table indicating registered service providers. The database 225 may be periodically updated by, or may periodically update, a database (e.g., roadside assistance service records 234) of the client portal 208-209. The list of service providers may include all or a portion of the registered service providers. In step 507, the selection engine 221 may determine one service provider from the list of service providers. For example, the selection engine 221 may select the first service provider listed in the list.

In step 509, the selection engine 221 may determine whether the service provider as determined in step 507 is active. If the service provider is active, the method may proceed to step 511. Otherwise, the method may proceed to step 523. The active status of a service provider may indicate that the service provider is working (like when an employee “punches-in” at work). The database 225 may, for example, store a record corresponding to a service provider, and the record may include a data field indicating whether the service provider is active or inactive. The selection engine 221 may determine whether the record indicates that the service provider is active.

In step 511, the selection engine 221 may determine whether the service provider as determined in step 507 is currently available to handle the received service request. If the service provider is available, the method may proceed to step 513. Otherwise, the method may proceed to step 523. A service provider might not be available if the service provider is currently handling another service request. If a service provider accepts another service request, the acceptance may be recorded by the database 225 (e.g., in a record corresponding to the service provider) indicating that the service provider is not currently available, until the service provider concludes with the other service request (e.g., by completion of the requested service, cancellation, etc.).

In step 513, the selection engine 221 may determine whether the service provider as determined in step 507 is associated with the geographical region in which the disabled user vehicle is located. If the service provider is associated with the geographical region, the method may proceed to step 515. Otherwise, the method may proceed to step 523. A service provider may provide roadside assistance services to one or more associated geographical regions. The association of a service provider with a geographical region may indicate that the service provider handles services requests generated from the geographical region.

The selection engine 221 may optionally determine whether the service provider as determined in step 507 is currently located within a threshold distance (e.g., 30 kilometers) to the disabled user vehicle. If the service provider is not currently located within the threshold distance to the disabled user vehicle, the selection engine 221 may determine not to include the service provider in the list of eligible service providers. The threshold distance may help avoid selecting, for handling the service request, a service provider that is located far away from the disabled user vehicle.

In step 515, the selection engine 221 may determine whether the service provider as determined in step 507 provides the requested or determined type of roadside assistance service (e.g., “service type”). If the service provider provides the requested type of roadside assistance service, the method may proceed to step 517. Otherwise, the method may proceed to step 523. A service provider may provide one or more types of services (e.g., tire change, oil delivery, etc.). The types of services provided by a service provider may be recorded in the database 225 (e.g., when the service provider is registered). The selection engine 221 may make the determination based on the information in the database 225. Furthermore, the types of service provided by the service provider may be relayed to client portal 208-209, which may gather real-time information of the types of service provided by various service providers in roadside assistance service records 234.

In step 517, the selection engine 221 may determine whether the service provider's charge for providing the requested service is below a threshold amount (e.g., 70 dollars for a tire change). If the service provider's charge is below the threshold amount, the method may proceed to step 519. Otherwise, the method may proceed to step 523. The threshold amount may be, for example, adjusted based on the average price for providing the requested type of service across the registered service providers. The threshold amount may alternatively correspond to other desired amounts, such as a certain percentage of the average price.

In step 519, the selection engine 221 may determine whether to exclude the service provider from the list of eligible service providers for other reasons. If the selection engine 221 determines to exclude the service provider for other reasons, the method may proceed to step 523. Otherwise, the method may proceed to step 521. As one example, the selection engine 221 may determine to exclude the service provider if the service provider previously provided roadside assistance service(s) to the user associated with the currently received service request, and if the user's feedback on the previously provided roadside assistance service(s) was negative (e.g., the user rated the service provider with one (1) star out of five (5) stars).

If the service provider as determined in step 507 satisfies the various criteria as discussed above, the selection engine 221 may include the service provider in the list of eligible service providers in step 521. Otherwise, the selection engine 221 might not include the service provider in the list of eligible service providers in step 523. After steps 521 or 523, the method may proceed to step 525. In step 525, the selection engine 221 may determine whether the list of service providers as determined in step 506 has been exhausted. If so, the method may proceed to step 527. Otherwise, the method may go back to step 507, in which the selection engine 221 may determine another service provider from the list of service providers as determined in step 506 (e.g., a service provider listed next to the previously selected service provider), and may determine whether the service provider may be included in the list of eligible service providers.

In step 527, the selection engine 221 may generate the list of eligible service providers. With reference to FIG. 5B, in step 529, the selection engine 221 may determine whether the list of eligible service providers is empty (e.g., include no members). For example, the list of eligible service providers may be empty if the current demand for roadside assistance services is higher than the current supply. If the list of eligible service providers is empty, the method may proceed to step 531. Otherwise, the method may proceed to step 533.

In step 531, the roadside assistance unit 211 may contact other networks related to providing roadside assistance services. For example, the roadside assistance unit 211 may request a call center agent to make a phone call to a traditional towing network comprising service providers not registered with the roadside assistance unit 211 (e.g., a tow truck company), and to ask if the traditional towing network is currently available to handle the service request. Additionally, the roadside assistance unit 211 may determine the geographical region in which the disabled user vehicle is located, the type of requested service, and the time and date that the service request was received, and may send, to the registration engine 223, a request to update service provider associations and/or to invite new service providers to register with the roadside assistance unit 211.

If the list of eligible service providers is not empty, the selection engine 221 may determine a weighted score for each service provider in the list, and may rank the service providers in the list based on their respective weighted scores, in order to determine the optimal service provider (e.g., having best job performance and/or lowest estimated time of arrival) to which to assign the received service request. In step 533, the selection engine 221 may determine a service provider from the list of eligible service providers. For example, the selection engine 221 may select the first service provider listed in the list of eligible service providers. The determined service provider may be assessed in subsequent steps with respect to various factors (e.g., related to job performance).

In step 535, the selection engine 221 may estimate the determined service provider's cost or price for providing the requested roadside assistance service. The service provider's fee arrangements may be established, for example, when the service provider registered with the roadside assistance unit 211, and may be stored in the database 225. The selection engine 221 may estimate the service provider's cost for providing the requested service based on the service provider's fee arrangements. For example, if the service provider charges a flat fee (e.g., 60 dollars) for the requested service (e.g., tire change), the estimated cost may correspond to the flat fee. Alternatively, the service provider may charge an hourly rate and/or a rate based on the distance traveled, in addition to a base amount. In such a situation, the selection engine 221 may estimate the distance that the service provider may travel to arrive at the disabled user vehicle (e.g., based on the current location of the service provider and the current location of the disabled user vehicle). The selection engine 221 may estimate the amount of time that the service provider may take to complete the requested service, for example, based on the distance that the service provider may travel, the type of requested service, the amount of time that the service provider historically used to complete the type of service, etc. If the service provider's cost is higher, the service provider may be less likely to be selected for handling the currently received request.

In step 537, the selection engine 221 may determine a likelihood of the service provider accepting the service request if the service request is assigned (e.g., forwarded) to the service provider. The service provider's likelihood of acceptance may be determined based on the service provider's historical acceptance rate, and may be specific to the geographical region and/or time. For example, every time a service request was assigned to the service provider, the system record whether the service provider accepted or rejected the service request. The service provider's historical acceptance rate may correspond to the total number of historical acceptances divided by the total number of assignments of service requests to the service provider.

Selecting a service provider with a high likelihood of acceptance may help reduce the time for a service request to be accepted. If a service request assigned to a service provider is rejected by the service provider, the roadside assistance unit 211 may need to assign the service request to another service provider, and the user of the disabled user vehicle may need to wait for a longer period of time for the service request to be accepted. If the service provider's likelihood of acceptance is higher, the service provider may be more likely to be selected for handling the currently received request.

In step 539, the selection engine 221 may determine an estimated time of arrival (ETA) for the service provider as determined in step 533 to arrive at the disabled user vehicle from the service provider's current location. The estimated time of arrival may be determined based on the location of the service provider and the location of the disabled user vehicle (and/or the distance between the service provider and the disabled user vehicle). The estimated time of arrival may also be adjusted based on real-time traffic pattern. The selection engine 221 may determine the estimated time of arrival using any type of route planning system or algorithm. If the service provider's estimated time of arrival for the currently received service request is longer, the service provider may be less likely to be selected for handling the currently received request.

In step 541, the selection engine 221 may determine an on-time score for the service provider as determined in step 533. The on-time score may correspond to a degree of the service provider's on-time commitment to users. For example, if for a particular service request, the service provider's estimated time of arrival is 30 minutes from the time of acceptance, and the service provider's actual time of arrival is 40 minutes from the time of acceptance, the user may feel negatively about the 10 minute delay.

The on-time score may be determined based on historical data associated with the service provider. For example, for each service request that the service provider accepted, the roadside assistance unit 211 may record the estimated time of arrival and the actual time of arrival, and may determine a time difference between the estimated time of arrival and the actual time of arrival. The on-time score may be based on an average of time differences for the service requests that the service provider accepted. Alternatively, the roadside assistance unit 211 may determine a percentage (e.g., corresponding to the time difference divided by the estimated time of arrival) for each service request, and the on-time score may be based on an average of percentages for the service requests that the service provider accepted. If the service provider's on-time score is higher, the service provider may be more likely to be selected for handling the currently received request.

The on-time score may be adjusted if the service provider provided responses to any delays. For example, for a particular service request where the service provider arrived at the location of the disabled user vehicle later than the estimated time of arrival, the service provider may have provided, to the system, a message indicating the reason for the delay. In such a situation, the system may adjust the on-time score in such a manner that the service provider may be more likely to be selected for handling the currently received request.

Additionally or alternatively, the roadside assistance unit 211 may adjust the service provider's estimated time of arrival (e.g., as determined in step 539) based on the service provider's on-time score and/or on-time record. For example, if the service provider on average arrives at the location of a disabled user vehicle ten (10) minutes later than the estimated time of arrival, the roadside assistance unit 211 may increase the service provider's estimated time of arrival (e.g., as determined in step 539) by ten (10) minutes. And the selection engine 221 may use the adjusted estimated time of arrival for calculating the weighted score for the service provider. Additionally, after the service request has been accepted, the adjusted estimated time of arrival may be provided to the user for the user's information.

In step 543, the selection engine 221 may determine a job performance score for the service provider based on historical data. The job performance score may indicate the service provider's job performance after the service provider has arrived at the location of a disabled user vehicle. The job performance score may be determined, for example, based on an average amount of time used for completion of a requested service (e.g., jump start). For example, the roadside assistance unit 211 may record a first time when the service provider arrives at the location of a disabled user vehicle. When the service provider completes the requested service, the service provider and/or the user may indicate to the roadside assistance unit 211 that the requested service has been completed, and the roadside assistance unit 211 may record a second time. The amount of time used for completion of the requested service may correspond to the second time minus the first time. For example, if the service provider arrives at the location of a disabled service vehicle and realizes that a tool or material needed to perform the requested service is missing, the service provider may need to retrieve the tool or material, and the time used for completion of the requested service may be high. If the time used for completion of the requested service is higher, the service provider may be less likely to be selected for handling the currently received request.

In step 545, the selection engine 221 may determine an extra cost for the service provider (e.g., based on historical data). The extra cost may indicate the cost incurred to the system, for example, because of the service provider's cancellation or late arrival. For example, if the service provider cancels an accepted service request, the roadside assistance unit 211 may need to use resources to find another service provider. Additionally, the user may call the roadside assistance unit 211 regarding the cancellation and may request the call center agent to find another service provider. If the service provider arrives at the location of a disabled user vehicle later than the estimated time of arrival, the user may also call the roadside assistance unit 211 regarding the delay. The calls from the user may incur additional cost (e.g., the call center agent's time) to the system. The extra cost for the service provider may be determined based on the number of user recalls to the system per service request and/or the amount of money charged by the call center agent for handling the user recalls per service request. If the extra cost for the service provider is higher, the service provider may be less likely to be selected for handling the currently received request.

In step 547, the selection engine 221 may determine a user feedback score for the service provider. For example, after a job is completed, the user may be prompted to enter his or her feedback on the service provided. The user may enter an overall rating for the service provided, may enter one or more ratings specific to aspects of the service provided (e.g., the service provider's timeliness, the service provider's demeanor, etc.), and/or may type in comments. The user feedback score for the service provider may correspond to, for example, an average of overall ratings for roadside assistance services provided by the service provider. Additionally or alternatively, the user feedback score for the service provider may be determined based on the one or more specific ratings or user comments. If the user feedback score is higher, the service provider may be more likely to be selected for handling the currently received request.

In step 549, the selection engine 221 may consider other factors related to selecting the optimal service provider to which to assign the service request. For example, the selection engine 221 may consider the service provider's cancellations of accepted service requests. If the service provider cancels accepted service requests with higher frequency, the service provider may be less likely to be selected for handling the currently received request. Additionally or alternatively, the selection engine 221 may consider the time period between the service provider's acceptance of a service request and the service provider's cancellation of the service request. If the time period is longer, the service provider may be less likely to be selected for handling the currently received request.

In step 551, the selection engine 221 may determine a weight for each factor relevant to selecting the optimal service provider to assign the service request. The weights for the factors may be determined based on a location associated with the roadside assistance unit 211. Users in different areas (e.g., New York City, Los Angeles) may have different preferences for aspects of a roadside assistance service. For example, on time arrival may be more important for users from one area, and short estimated time of arrival may be more important for users from another area. Based on general preferences of users in the area of the roadside assistance unit 211 (e.g., the area in which users of the system are located), the selection engine 221 may determine to give more weight to a preferred factor.

Additionally or alternatively, the roadside assistance unit 211 may determine individualized preferences, and may store the information in the database 225. The individualized preference information may be associated with each user. The roadside assistance unit 211 may prompt the user to enter his or her preference information, for example, via a user interface. Additionally or alternatively, the roadside assistance unit 211 may determine a user's preferences based on user's feedback on previously received roadside assistance services. The roadside assistance unit 211 may determine whether there is a correlation between each factor and the user's overall rating. For example, if every time a service provider arrives later than the estimated time of arrival, the user gives a low feedback rating, and every time the user gives a low feedback rating, the service provider arrives late than the estimated time of arrival, the roadside assistance unit 211 may determine that the user prefers on time arrival, and may give more weight to the on-time score factor. The roadside assistance unit 211 may also determine a user's preference based on a user's comments or a user's indicated reasons for a low feedback rating. The roadside assistance unit 211 may determine the weights for the factors based on the individualized preferences associated with the user that sent the service request received by the system.

The weights may be applied to the factors to prioritize some factors over others. For example, the selection engine 221 may assign a weight of four (4) to the on-time score, a weight of three (3) to the service provider's cost, and a weight of one (1) to the likelihood of acceptance, etc. In step 553, the roadside assistance unit 211 may determine a weighted score for the service provider. If k represents a particular service provider, the absolute value of Wᵢ(k) represents the weight assigned to a given factor i (e.g., on-time score) for the service provider k, Tᵢ(k) represents the value of the given factor i for the service provider k, and S(k) represents the weighted score for the service provider k, the weighted score may be calculated according to the following equation:

$$S ( k ) = {\sum }_{i = 1}^{N} {W}_{i} ( k ) * {T}_{i} ( k ) \qquad ( 2 )$$

Wᵢ(k) may be set to be a positive value or a negative value based on how each factor may affect (e.g., positively or negatively) the likelihood of the service provider to be selected for handling the received service request, so that the factors may consistently contribute to the weighted score S(k). For example, if the Wᵢ(k) for the service provider's likelihood of acceptance is a positive value, the Wᵢ(k) for the service provider cost may be a negative value. Additionally or alternatively, the roadside assistance unit 211 may determine distributions for the factors. The distributions may vary in type and/or calculation based on the factor. With the distributions, the raw values of the factors may be provided with context. One exemplary distribution may be a normal (e.g., Gaussian) distribution. The system may determine the standard deviation of a factor value associated with a service provider versus the average factor value for any service providers. Other statistical methods useful for analyzing data may be applied.

In implementations where a computing system (e.g., a roadside assistance unit or its call center), which is distinct from the client portal 208-209 performs the steps of scoring and/or assessing the service provider (e.g., steps 533 through steps 553), step 554 may include sending one or more of the above-described assessments of the service provider to the client portal 208-209. Thus, the roadside assistance unit may send the determined weighted score, an assessment of the various factors of the weighted score, the service provider's user feedback, the service provider's job performance score, the service provider's on-time score, the service provider's estimated time of arrival, the service provider's estimated cost or extra costs, and/or the service provider's likelihood of accepting the request. As described herein, the client portal 208-209 may associate this information to the service provider based on the service provider identification.

In step 555, the selection engine 221 may determine whether a weighted score has been determined for each service provider of the list of eligible service providers as determined in step 527. If so, the method may proceed to step 557 of FIG. 5C. Otherwise, the method may go back to step 533, in which the selection engine 221 may select another service provider from the list of eligible service providers, and may determine a weighted score for the service provider. With reference to FIG. 5C, in step 557, the selection engine 221 may order the list of eligible service providers based on their respective weighted scores (e.g., from large scores to small scores). The selection engine 221 may generate a list of ordered service providers.

In step 559, the selection engine 221 may adjust the list of ordered service providers. For example, a service provider in the list of ordered service providers may have arrangements with the roadside assistance unit 211. For example, the service provider may agree to provide roadside assistance services at discount prices if the service provider is prioritized during the service provider ordering. In such a situation, the selection engine 221 may move the service provider to the top of the list or change the service provider to a higher ranking in the list.

In step 561, the selection engine 221 may select a service provider (e.g., a top ranking service provider) from the list of ordered service providers. In step 563, the roadside assistance unit 211 may assign the service request to the selected service provider. For example, the application server 217 may send a message to an application running on a service provider computing device associated with the selected service provider. The message may indicate that the user is requesting a roadside assistance service. The message may indicate information related to the service request, such as the user's identity, the location of the disabled user vehicle, the type of roadside assistance service requested, etc. The information indicated in the message may be presented on a user interface of the application.

In step 565, the roadside assistance unit 211 may determine whether the service provider accepts the service request within a time threshold (e.g., two (2) minutes). The service provider may, for example, click an “accept” or “reject” button shown on the user interface of the application, and the acceptance or rejection may be sent to the roadside assistance unit 211. If the service provider accepts the service request within the time threshold, the method may proceed to step 567. Otherwise, the method may go back to step 561, in which the roadside assistance unit 211 may select a next service provider from the list of ordered service providers (e.g., a service provider listed next to the previously selected service provider).

In step 567, the roadside assistance unit 211 may update the user with the service provider's acceptance. For example, the application server 217 may send, to a computing device associated with the user, one or more messages indicating the service provider's acceptance. The messages may indicate an estimated time of arrival of the service provider. The application server 217 may also send real-time location information of the service provider to the user. Thereafter, the application server may also signal the client portal 208-209 of the acceptance (e.g., as in step 568). In step 569 in FIG. 5D, the roadside assistance unit 211 may monitor the service provider's movement. The location of the service vehicle and/or the service provider may be obtained and sent to the roadside assistance unit 211, for example, using telematics. In further implementations, the client portal 208-209 may establish a connection with the telematics or global positioning system of the service provider and also monitor the service provider's movement in real-time. Alternatively or additionally, the roadside assistance unit 211 may send data regarding the service provider's movement to the client portal 208-209. As one example, if the system detects erratic behavior of the service provider, the system may request a case manager to preempt the service provider's delay or cancellation.

In step 571, the roadside assistance unit 211 may determine whether the service provider is proceeding normally to the disabled user vehicle. For example, the roadside assistance unit 211 may determine whether the service provider deviates from the planned route to the user to a threshold degree. The roadside assistance unit 211 may determine a planned route based on the location of the disabled user vehicle and the location of the service provider using any type of route planning system or algorithm (e.g., so that the estimated time of arrival may be the shortest). If the current location of the service provider indicates that the service provider is deviating from the planned route (e.g., if the service provider's distance to a closet point in the planned route is higher than a threshold distance), the system may determine that the service provider is not proceeding normally to the disabled user vehicle.

Additionally or alternatively, the roadside assistance unit 211 may determine whether the service provider is going to arrive at the disabled user vehicle on time. If the service provider's speed is below a threshold speed (e.g., 10 kilometers per hour) for a threshold amount of time (e.g., 5 minutes), the roadside assistance unit 211 may determine that the service provider is not proceeding normally to the disabled user vehicle. Additionally or alternatively, if the service provider's speed is not consistent with the traffic pattern of the road on which it is moving (e.g., moving 10 kilometers per hour on a high way when the overall traffic is light on the high way), the roadside assistance unit 211 may determine that the service provider is not proceeding normally to the disabled user vehicle.

If the roadside assistance unit 211 determines that the service provider is not proceeding normally to the disabled user vehicle, the method may proceed to step 573. In step 573, the roadside assistance unit 211 may send a notice to the service provider. For example, the application server 217 may send, to the service provider computing device, a message indicating that the service provider is not proceeding normally to the user. The message may prompt the service provider to enter a response indicating the reason for not proceeding normally to the user. In step 575, the roadside assistance unit 211 may determine whether a response is received from the service provider within a time threshold (e.g., one (1) minute). The response may be, for example, a voice message, a text message, etc.

If the roadside assistance unit 211 receives a response from the service provider with the time threshold, the method may proceed to step 577. In step 577, the roadside assistance unit 211 may determine whether the service provider returns to the planned route within a first time threshold (e.g., three (3) minutes). The first time threshold may be adjusted, for example, based on the response provided by the service provider. The response provided by the service provider may be processed using any type of voice recognition and/or natural language processing algorithm, to determine one or more events that caused the service provider not to proceed normally to the user, such as the service provider being stopped by the police because of speeding, the service provider's vehicle having a flat tire, the service provider being trapped in a traffic congestion, etc. The roadside assistance unit 211 may store a mapping between various types of situations and corresponding time thresholds used for resolving the situations. The first time threshold may be determined based on the mapping.

The roadside assistance unit 211 may determine whether the service provider returns to the planned route and/or returns to proceeding normally to the user within the first time threshold. If so, the method may go back to step 569, in which the roadside assistance unit 211 may continue monitoring the service provider's movement. Otherwise, the method may proceed to step 579. In step 579, the roadside assistance unit 211 may cancel the assignment of the service request to service provider. The roadside assistance unit 211 may notify the service provider and/or the user of the cancellation. The method may go back to step 561 in FIG. 5C, in which the roadside assistance unit 211 may select a next service provider from the list of ordered service providers (e.g., a service provider listed next to the previously selected service provider).

If the roadside assistance unit 211 does not receive a response from the service provider with the time threshold (step 575: N), the method may proceed to step 581. In step 581, the roadside assistance unit 211 may determine whether the service provider returns to the planned route within a second time threshold (e.g., one (1) minutes). The second time threshold may be same as or different from the first time threshold. As one example, the second time threshold may be set to be shorter than the first time threshold because the service provider failed to provide a response and/or excuse for the delay.

If the roadside assistance unit 211 determines that the service provider returns to the planned route and/or returns to proceeding normally to the user within the second time threshold, the method may go back to step 569. Otherwise, the method may proceed to step 583. In step 583, the roadside assistance unit 211 may cancel the assignment of the service request to service provider. The roadside assistance unit 211 may notify the service provider and/or the user of the cancellation. Furthermore, the roadside assistance unit 211 may notify the client portal 208-209 of the cancellation (e.g., as in step 584). The method may go back to step 561, in which the roadside assistance unit 211 may select a next service provider from the list of ordered service providers (e.g., a service provider listed next to the previously selected service provider).

If the roadside assistance unit 211 determines that the service provider is proceeding normally to the disabled user vehicle (step 571: Y), the method may proceed to step 585. In step 585, the roadside assistance unit 211 may determine whether the service provider arrives at the location of the disabled user vehicle. As one example, the service provider may enter, into a user interface of the application running on the service provider computing device, an indication that the service provider has arrived at the location of the disabled user vehicle. Additionally or alternatively, the roadside assistance unit 211 may monitor the service provider's real-time location, and determine whether the service provider arrives at the location of the disabled user vehicle based on the real-time location information. If the service provider arrives at the location of the disabled user vehicle, the roadside assistance unit 211 may record the service provider's actual time of arrival, and may the method may proceed to step 587. Otherwise, the method may go back to step 569. In implementations where the monitoring of the service provider's movements via the telematics system or GPS is being performed by a computing system other than the client portal 208-209, step 586 may include signaling the client portal 208-209 of the service provider's arrival.

In step 587, the roadside assistance unit 211 may determine whether the requested roadside assistance service has been completed. If so, the roadside assistance unit 211 may record the service provider's time of completion of the requested service, and the method may proceed to step 589. Otherwise, the roadside assistance unit 211 may keep determining whether the requested roadside assistance service has been completed. The service provider and/or the user may indicate that a requested roadside assistance service has been completed, for example, by entering, into an application user interface, an indication that the requested service has been completed. The application user interface may be shared or readily accessible by the client portal 208-209 to allow the client to receive real-time notifications, e.g., of the job completion. In implementations where the computing system that determines at step 587 is distinct from the client portal 208-209, step 588 may include signaling the client portal and/or client portal unit of the job completion if the job has been completed.

In step 589, the roadside assistance unit 211 may obtain feedback from the user regarding the roadside assistance service provided by the service provider. For example, the roadside assistance unit 211 may prompt the user to enter one or more ratings of the provided roadside assistance service (e.g., an overall rating and/or one or more ratings regarding aspects of the provided roadside assistance service). The roadside assistance unit 211 may also prompt the user to enter comments regarding the provided roadside assistance service. The user feedback may be received by the roadside assistance unit 211, and may be stored in the database 225. Furthermore, the user feedback may be relayed by the roadside assistance unit 211 to, or may be simultaneously sent to, the client portal 208-209 (e.g., as in step 590).

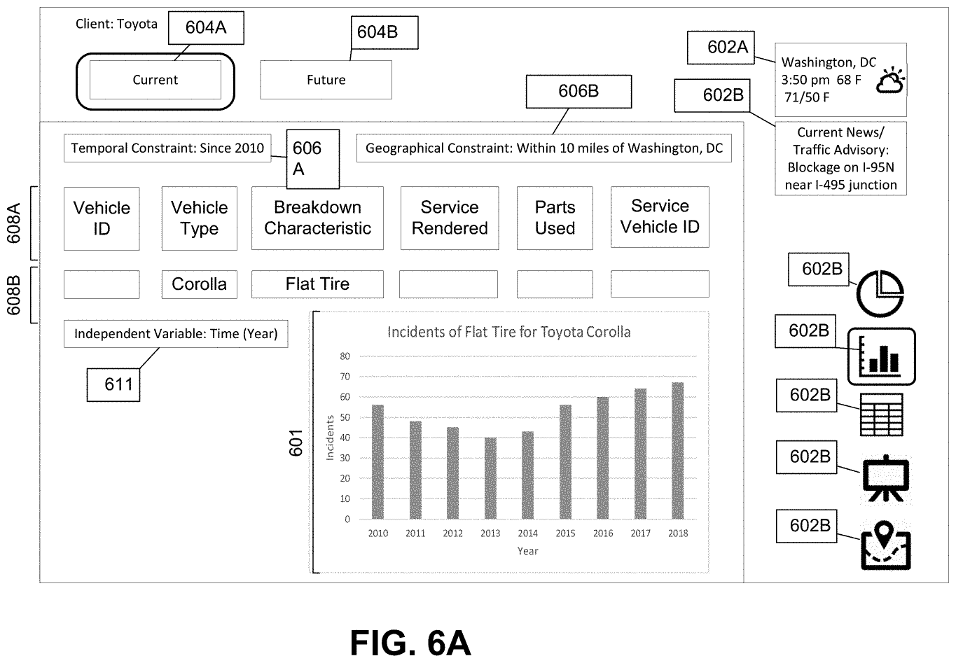

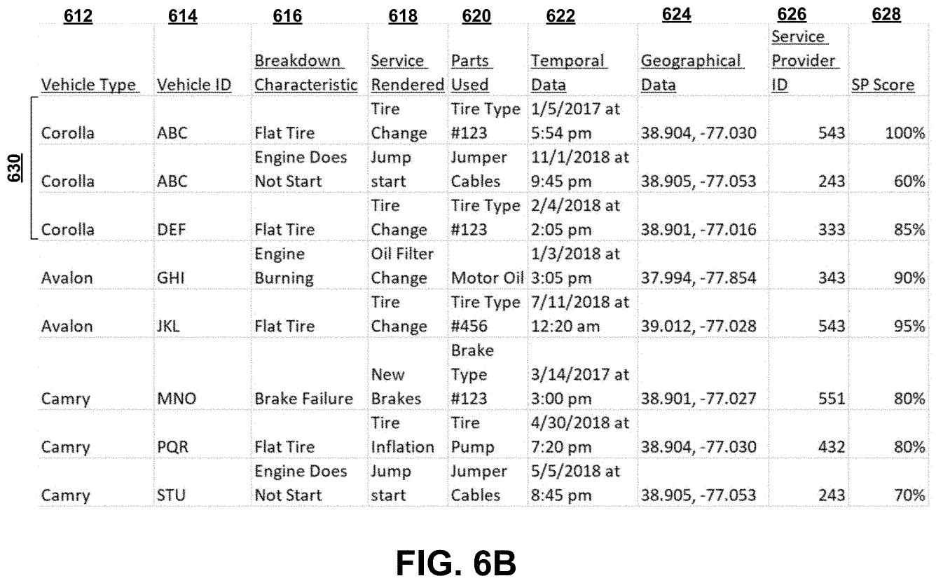

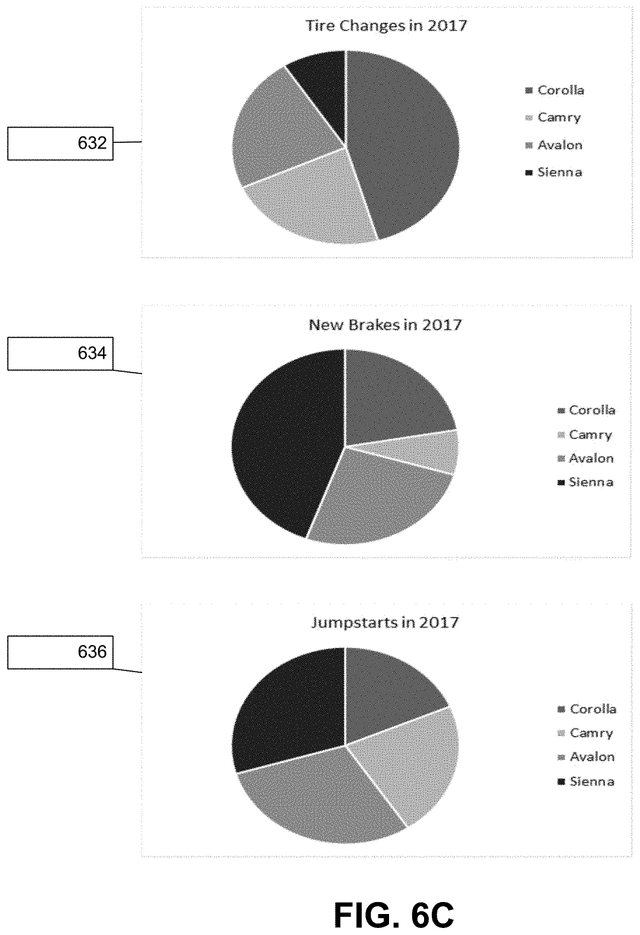

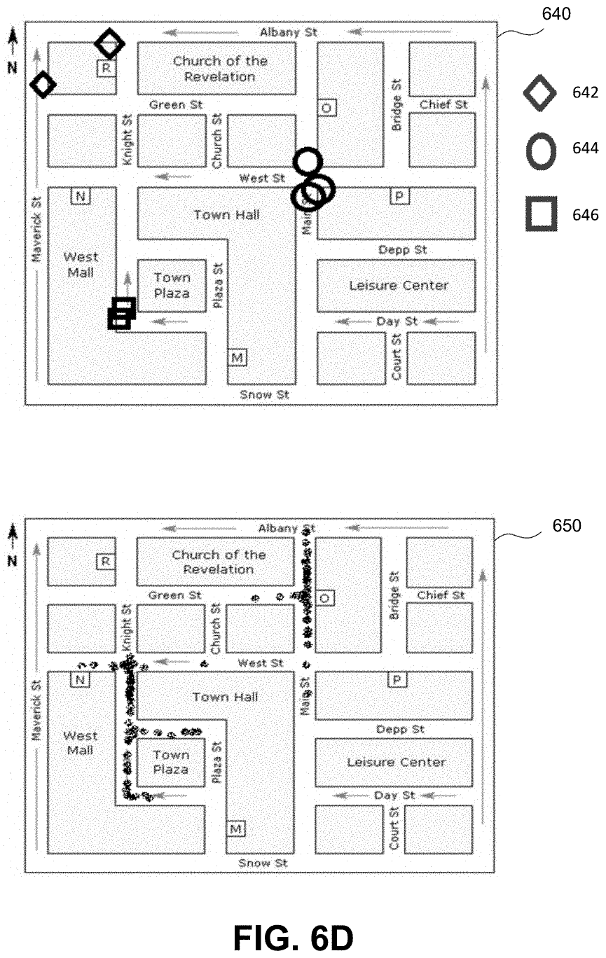

FIGS. 6A-6D are exemplary displays of a user interface for analyzing roadside assistance service of vehicles in real time, according to one or more aspects described herein. For example, FIG. 6A depicts an exemplary home page display of the user interface of the client portal device 208, which may allow a client user (e.g., vehicle manufacturer and/or dealer) to analyze roadside assistance service of vehicles in real-time. As seen in FIG. 6A, the user interface may provide real-time weather alerts 602A and/or real-time news and traffic alerts 602B, for a desired location (e.g., Washington, D.C.), especially as it pertains to vehicles and roadside assistance services (e.g., “Blockage on I-95 N, near I-495 junction”). The user interface may enable a client user to analyze current trends 604A and future trends 604B, of which the methods for analysis have been discussed above in relation to FIG. 3B. For example, the display presented in FIG. 6A depicts a selection to analyze current trends. A client may be able to filter results or guide the analysis by choosing temporal constraints 606A (e.g., “Since 2010”) and/or geographical constraints 606B (e.g., “Within 10 miles of Washington, D.C.”). Furthermore, one or more parameters 608A may be selected and/or described by entering or selecting a profile 608B for the selected parameter. As depicted in FIG. 6A, the client user has selected the profile “Corolla” for the Vehicle Type parameter, and the user has selected the profile “Flat Tire” for the Breakdown Characteristic parameter. The user did not select other parameters for filtering the results or guiding the analysis. The user interface may also enable a client user to select from a variety of presentation options (e.g., graph(s) 610A, chart(s) 610B, spreadsheet(s) 610C, slides(s) 610D, map(s) 610E, etc. In some implementations, e.g., for presentation options that enable the viewing of at least two dimensional data, the user interface may enable the client user to select an independent variable 611 (e.g., “Time (Years)”). As a result of these selections, the user interface depicts a chart 601 of the incidents of flat tire (a breakdown characteristic) for a Toyota Corolla (a vehicle type) since 2010 (a temporal constraint).

FIG. 6B depicts an exemplary presentation (e.g., spreadsheet) comprising data for various parameters. These parameters may include, but are not limited to vehicle type 612, vehicle ID 614, breakdown characteristic 616, service rendered 618, parts used 620, temporal data 622, geographical data 624, service provider ID 626, and service provider score 628. As was discussed above, information pertaining to a parameter may be stored within data structures of the memory of the client portal 208-209, and may be associated with the data structures of other parameters. The spreadsheet illustrates at least one way of organizing the various parameters. For example, a single vehicle type 612 (e.g., Corolla 630) may have two individual vehicles represented by their vehicle IDs. 614 At each row, a different breakdown incident has occurred. The breakdown incident may be described by the breakdown characteristic 616 as reported by the vehicle user. For each breakdown characteristic 616 listed, there may be a service type 618 determined or rendered on the vehicle to address or fix the breakdown characteristic. Parts may be used 620 in the service. Each incident may be have occurred during a certain time and/or date (e.g., temporal data 622), and under a specific location (e.g., geographical data 624). The service provider that attended to the service may be represented by a service provider ID 616, and its service may have been assessed. The assessment may be stored, e.g., as service provider score 628.

FIG. 6C depicts exemplary presentations of graphs (e.g., pie shaped graphs) comprising data for a plurality of parameters. The graphs can be distinguished by the service types for which it represents data. The graphs may also commonly share the parameters of vehicle types (e.g., Corolla, Camry, Avalon, and Sienna) and a temporal constraint (e.g., 2017). For example, the top graph 632 shows the proportion of tire changes in 2017 among the four vehicle types, the middle graph 634 represent the proportion of new brakes in 2017 among the four vehicle types, and the bottom graph 636 represent proportions of jumpstarts among the four vehicle types.

FIG. 6D depicts exemplary presentations of maps, 640 and 650, showing real-time data relevant to roadside assistance service of vehicles. The maps may commonly share a geographic constraint, e.g., of an area in a city. Map 640 may depict locations at which incidents of various breakdowns may have occurred. The breakdown incidents may be classified by their breakdown characteristics. For example, incidents of flat tires 642 may be shown as a diamond, incidents of a broken engine 644 may be shown as a square, and incidents of a brake failure 646 may be shown as a circle. While not shown, map 640 may also be based on a temporal constraint, such that the map may be enabled to only display locations for incidents that have occurred after and/or before a specific time. Map 650 may depict, in real-time traffic densities, for example, at 652 and 654. The user interface may enable a closer view of the map to identify individual vehicles (e.g., by their vehicle IDs and/or vehicle types).

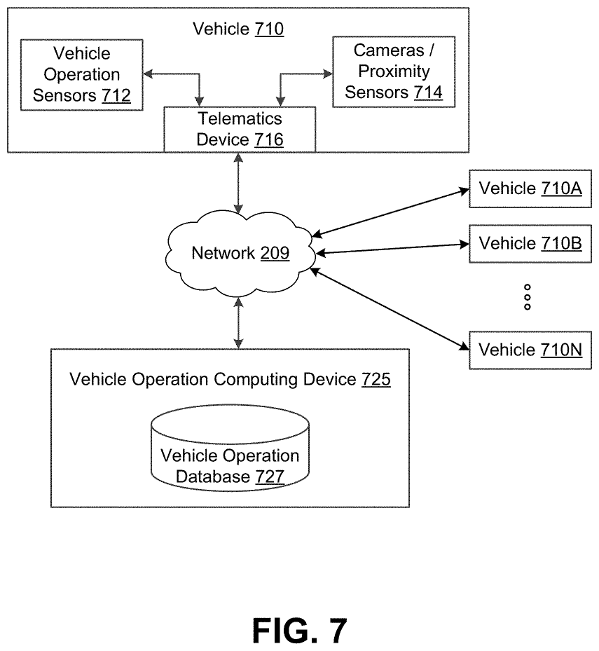

FIG. 7 is a schematic diagram showing an example system for determining roadside assistance service parameters according to one or more aspects described herein. Each component shown in FIG. 7 may be implemented in hardware, software, or a combination of the two. Additionally, each component of the system may include a computing device (or system) having some or all of the structural components described above for computing device 101. The system shown in FIG. 7 may include a vehicle 710, such as an automobile, motorcycle, etc. The vehicle 710 may be used to implement the terminal 161, the user vehicle 201, the service vehicles 203A-203N, and/or the client portal 208. The vehicle 710 may comprise one or more sensors as described below. The one or more sensors may additionally or alternatively be included in any type of device, such as the terminal 151, the user computing device 205, and/or the service provider computing devices 207A-207N.

The vehicle 710 may include vehicle operation sensors 712 capable of detecting and recording various conditions at the vehicle and operational parameters of the vehicle. For example, sensors 712 may detect and store data corresponding to the vehicle's speed, distances driven, rates of acceleration or braking, and specific instances of sudden acceleration, braking, and swerving. Sensors 712 also may detect and store data received from the vehicle's 710 internal systems, such as impact to the body of the vehicle, air bag deployment, headlights usage, brake light operation, door opening and closing, door locking and unlocking, cruise control usage, hazard lights usage, windshield wiper usage, horn usage, turn signal usage, seat belt usage, phone and radio usage within the vehicle, maintenance performed on the vehicle, and other data collected by the vehicle's computer systems.

Additional sensors 712 may detect and store the external driving conditions, for example, external temperature, rain, snow, light levels, and sun position for driver visibility. Sensors 712 also may detect and store data relating to moving violations and the observance of traffic signals and signs by the vehicle 710. Additional sensors 712 may detect and store data relating to the maintenance of the vehicle 710, such as the engine status, oil level, engine coolant temperature, odometer reading, the level of fuel in the fuel tank, engine revolutions per minute (RPMs), and/or tire pressure.

The vehicle 710 also may include one or more cameras and proximity sensors 714 capable of recording additional conditions inside or outside of the vehicle 710. Internal cameras 714 may detect conditions such as the number of the passengers in the vehicle 710, and potential sources of driver distraction within the vehicle (e.g., pets, phone usage, and unsecured objects in the vehicle). External cameras and proximity sensors 714 may detect other nearby vehicles, traffic levels, road conditions, traffic obstructions, animals, cyclists, pedestrians, and other conditions that may factor into a driving event data analysis.

The operation sensors 712 and the cameras and proximity sensors 714 may store data within the vehicle 710, and/or may transmit the data to one or more external computer systems (e.g., a vehicle operation computer system 725). The operation sensors 712, and the cameras and proximity sensors 714, may be configured to transmit data to a vehicle operation computer system 725 via a telematics device 716 and the network 210. In other examples, one or more of the operation sensors 712 and/or the cameras and proximity sensors 714 may be configured to transmit data directly without using a telematics device 716. For example, telematics device 716 may be configured to receive and transmit data from operation sensors 712, while one or more cameras and proximity sensors 714 may be configured to directly transmit data to a vehicle operation computer system 725 without using the telematics device 716. Thus, telematics device 716 may be optional in certain examples where one or more sensors or cameras 712 and 714 within the vehicle 710 may be configured to independently capture, store, and transmit vehicle operation and driving data.

Telematics device 716 may be a computing device containing some or all of the hardware and/or software components as the computing device 101 shown in FIG. 1. The telematics device 716 may receive vehicle operation and driving data from vehicle operation sensors 712, and proximity sensors and cameras 714, and may transmit the data to one or more external computer systems (e.g., a vehicle operation computer system 725) over a wireless transmission network (e.g., the network 210). Telematics device 716 also may be configured to detect or determine additional types of data relating to real-time driving and the condition of the vehicle 710. In certain embodiments, the telematics device 716 may contain or may be integral with one or more of the vehicle sensors 712 and proximity sensors and cameras 714, and/or with one or more additional or alternative sensors.

The telematics device 716 may be configured to collect data regarding the number of passengers and the types of passengers (e.g. adults, children, teenagers, pets, etc.) in the vehicle 710. The telematics device 716 also may be configured to collect data of a driver's movements or the condition of a driver. For example, the telematics device 716 may include or communicate with sensors that monitor a driver's movements, such as the driver's eye position and/or head position, etc. Additionally, the telematics device 716 may collect data regarding the physical or mental state of the driver, such as fatigue or intoxication. The condition of the driver may be determined through the movements of the driver or through sensors, for example, sensors that detect the content of alcohol in the air or blood alcohol content of the driver, such as a breathalyzer.

The telematics device 716 also may collect information regarding the driver's route choice, whether the driver follows a given route, and to classify the type of trip (e.g. commute, errand, new route, etc.). In certain embodiments, the telematics device 716 may be configured to communicate with the sensors and/or cameras 712 and 714 to determine when and how often the vehicle 710 stays in a single lane or strays into other lanes. To determine the vehicle's route, lane position, and other data, the telematics device 716 may include or may receive data from a mobile device, a Global Positioning System (GPS), locational sensors positioned inside a vehicle, or locational sensors or devices remote from the vehicle 710.

The telematics device 716 also may store the type of the vehicle 710, for example, the make, model, trim (or sub-model), year, and/or engine specifications. The vehicle type may be programmed into the telematics device 716 by a user or customer, determined by accessing a remote computer system, such as an insurance company or financial institution server, or may be determined from the vehicle itself (e.g., by accessing the vehicle's 710 computer systems).

Vehicle operation computer system 725 may be a computing device separate from the vehicle 710, including some or all of the hardware and/or software components as the computing device 101 depicted in FIG. 1. The vehicle operation computer system 725 may be implemented as part of or connected to the roadside assistance unit 211. The roadside assistance unit 211 may be configured to use the data obtained by and/or stored in the vehicle operation computer system 725 for the various processes performed by the roadside assistance unit 211 as described herein.

The vehicle operation computer system 725 may be configured to receive and store the vehicle operation data discussed above from vehicle 710, and similar vehicle operation data from one or more other vehicles 710A-710N. For example, the vehicle operation computer system 725 includes a vehicle operation database 727 that may be configured to store the vehicle operation data collected from the vehicle operation sensors 712, proximity sensors and cameras 714, and telematics devices 716 of one or more vehicles. The vehicle operation database 727 may store operational sensor data, proximity sensor data, camera data (e.g., image, audio, and/or video), location data, and/or time data for one or more vehicles.

Data stored in the vehicle operation database 727 may be organized in any of several different manners. For example, a table in the vehicle operation database 727 may include all of the vehicle operation data for a specific vehicle, similar to a vehicle event log. Other tables in the vehicle operation database 727 may store certain types of data for multiple vehicles. For instance, tables may store specific driving behaviors (e.g., driving speed, acceleration and braking rates, swerving, tailgating, use of seat belts, turn signals or other vehicle controls, etc.) for multiples vehicles at specific locations, such as specific neighborhoods, roads, or intersections. Vehicle operation data may also be organized by time, so that the driving events or behaviors of multiples vehicles may be stored or grouped by time (e.g., morning, afternoon, late night, rush hour, weekends, etc.) as well as location.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. Further, one or more aspects described with respect to one figure or arrangement may be used in conjunction with other aspects associated with another figure or portion of the description.

What is claimed is:

1. A system comprising:
one or more processors; and
memory storing instructions that, when executed by the one or more processors, cause the system to:
receive a request to treat a current breakdown of at least an aspect of a vehicle, wherein the request includes a vehicle location and a vehicle identification;
identify, from a plurality of stored vehicle profiles, a vehicle profile based on the vehicle identification;
determine, based on the vehicle location and a breakdown characteristic of the vehicle, a service to treat the current breakdown, and a service vehicle from a plurality of service vehicles to render the service; and
update the identified vehicle profile based on one or more of: the vehicle location, the breakdown characteristic of the vehicle, and the service rendered.

2. The system of claim 1, wherein the determining the service vehicle from the plurality of service vehicles further causes the system to:
prompt an input of a plurality of responses, wherein the plurality of responses identifies the breakdown characteristic;
determine that the service vehicle from the plurality of service vehicles has the capability to perform the service to treat the current breakdown; and
determine that the service vehicle from the plurality of service vehicles is within a threshold distance to the vehicle location.

3. The system of claim 1, wherein the instructions, when executed by the one or more processors, further cause the system to:
receive and store one or more weighted scores associated with the service vehicle or the service rendered.

4. The system of claim 3, wherein the receiving and storing the one or more weighted scores associated with the service vehicle or the service rendered further cause the system to:
determine, based on one or more of the vehicle location, the vehicle profile, the breakdown characteristic, and the service rendered, one or more weights respectively associated with one or more factors;
receive an input of a value for each of the one or more factors;
determine, based on the one or more weights and values for the one or more factors, a weighted score of the one or more weighted scores.

5. The system of claim 4, wherein the one or more factors comprise one or more of a service cost, an acceptance rate, an on-time score, a service performance score, an extra cost, or a user feedback score.

6. The system of claim 1, wherein the instructions, when executed by the one or more processors, further cause the system to:
receive a request to display data pertaining to one or more of a vehicle, a breakdown characteristic, a service, or a service vehicle;
determine the data pertaining to the one or more of the vehicle, the breakdown characteristic, the service, or the service vehicle, based on a search of one or more vehicle profiles of the plurality of stored vehicle profiles; and
display the data pertaining to the one or more of the vehicle, the breakdown characteristic, the service, or the service vehicle.

7. The system of claim 6, wherein the data pertaining to the one or more of the vehicle, the breakdown characteristic, the service, or the service vehicle includes weather and traffic affecting the vehicle, the breakdown characteristic, the service, or the service vehicle.

8. The system of claim 1, wherein the instructions, when executed by the one or more processors, further cause the system to:
identify, from a plurality of stored breakdown profiles, a breakdown profile based on the determined breakdown characteristic of the vehicle;
update the identified breakdown profile based on one or more of: the vehicle location, the breakdown characteristic, and the service rendered;
receive a request to display data pertaining to one or more of a vehicle, a breakdown characteristic, a service, or a service vehicle;
determining data pertaining to the one or more of the vehicle, the breakdown characteristic, the service, or the service vehicle, based on a search of one or more breakdown profiles of the plurality of stored breakdown profiles; and
displaying the data pertaining to the one or more of the vehicle, the breakdown characteristic, the service, or the service vehicle.

9. The system of claim 1, wherein the instructions, when executed by the one or more processors, further cause the system to:
identify, from a plurality of stored service profiles, a service profile based on the service rendered;
update the identified service profile based on one or more of: the vehicle location, the breakdown characteristic, the service rendered, and the determined service vehicle;
receive a request to display data pertaining to one or more of a vehicle, a breakdown characteristic, a service, or a service vehicle;
determining data pertaining to the one or more of the vehicle, the breakdown characteristic, the service, or the service vehicle, based on a search of one or more service profiles of the plurality of stored breakdown profiles; and
displaying the data pertaining to the one or more of the vehicle, the breakdown characteristic, the service, or the service vehicle.

10. The system of claim 1, wherein the instructions, when executed by the one or more processors, further cause the system to:
forecast a future breakdown of an identified vehicle based on the vehicle profile of the identified vehicle, wherein the forecast of the future breakdown includes at least a breakdown characteristic of the identified vehicle during the forecasted breakdown.

11. The system of claim 10, wherein the forecast of the breakdown further includes a vehicle location during the forecasted breakdown.

12. The system of claim 11, wherein the instructions, when executed by the one or more processors, further cause the system to:
determine, based on the vehicle location and a breakdown characteristic of the vehicle, a service to treat the future breakdown, and a service vehicle from a plurality of service vehicles to render the service.

12. A method comprising:
receiving, by a computing device having at least one processor, a request to treat a current breakdown of at least an aspect of a vehicle, wherein the request includes a vehicle location and a vehicle identification;
identifying, by the at least one processor and from a plurality of stored vehicle profiles, a vehicle profile based on the vehicle identification;
determining, by the at least one processor and based on the vehicle location and a breakdown characteristic of the vehicle, a service to treat the current breakdown, and a service vehicle from a plurality of service vehicles to render the service; and
updating, by the at least one processor, the identified vehicle profile based on one or more of: the vehicle location, the breakdown characteristic of the vehicle, and the service rendered.

13. The method of claim 12, wherein the determining, by the at least one processor, the service vehicle from the plurality of service vehicles further comprises:
prompting, by the at least one processor, an input of a plurality of responses, wherein the plurality of responses identify the breakdown characteristic;
determining, by the at least one processor, that the service vehicle from the plurality of service vehicles has the capability to perform the service to treat the current breakdown; and
determining, by the at least one processor, that the service vehicle from the plurality of service vehicles is within a threshold distance to the vehicle location.

14. The method of claim 1, further comprising:
receiving and storing, by the at least one processor, one or more weighted scores associated with the service vehicle or the service rendered.

15. The method of claim 14, wherein the receiving and storing, by the at least one processor, the one or more weighted scores associated with the service vehicle or the service rendered further cause the system to:
determine, by the at least one processor and based on one or more of the vehicle location, the vehicle profile, the breakdown characteristic, and the service rendered, one or more weights respectively associated with one or more factors;
receive, by the at least one processor, an input of a value for each of the one or more factors;
determine, by the at least one processor and based on the one or more weights and values for the one or more factors, a weighted score of the one or more weighted scores.

16. The method of claim 12, further comprising:
receiving, by the at least one processor, a request to display data pertaining to one or more of a vehicle, a breakdown characteristic, a service, or a service vehicle;
determining, by the at least one processor, the data pertaining to the one or more of the vehicle, the breakdown characteristic, the service, or the service vehicle, based on a search of one or more vehicle profiles of the plurality of stored vehicle profiles; and
displaying, by the at least one processor, the data pertaining to the one or more of the vehicle, the breakdown characteristic, the service, or the service vehicle.

17. The method of claim 12, further comprising:
forecasting, by the at least one processor, a future breakdown of an identified vehicle based on the vehicle profile of the identified vehicle, wherein the forecast of the future breakdown includes at least a breakdown characteristic of the identified vehicle and a vehicle location during the forecasted breakdown.

18. The method of claim 17, further comprising:
determining, by the at least one processor and based on the vehicle location and a breakdown characteristic of the vehicle, a service to treat the future breakdown, and a service vehicle from a plurality of service vehicles to render the service.

19. A method comprising:
receiving, by a computing device having at least one processor, a request to forecast a future breakdown of a consumer vehicle;
identifying, by the at least one processor and from a plurality of stored vehicle profiles, a vehicle profile based on a vehicle identification of the consumer vehicle;
determining, by the at least one processor and from the identified vehicle profile and for each of a plurality of vehicles represented by the vehicle profile, one or more of a breakdown characteristic, a service, and a vehicle location during a past breakdown;
forecasting, by the at least one processor, a future breakdown of the consumer vehicle based on the determined breakdown characteristic, the service, and the vehicle location for each of the plurality of vehicles represented by the vehicle profile, wherein the forecast of the future breakdown includes at least a breakdown characteristic of the consumer vehicle and a vehicle location during the forecasted breakdown.

20. The method of claim 19, further comprising:
determining, by the at least one processor and based on the vehicle location and a breakdown characteristic of the vehicle, a service to treat the future breakdown, and a service vehicle from a plurality of service vehicles to render the service.
